(19) United States
(12) Patent Application Publication
(10) Pub. No.: US 2025/0303657 A1
(43) Pub. Date: Oct. 2, 2025

(54) JOINING A TYRE BASE LAYER

(71) Applicant: RETYRE AS, North Follo (NO)

(72) Inventors: Paul Magne Amundsen, Oslo (NO); Sigmund Andenes, Oslo (NO); Tarjei Aure Hofset, Oslo (NO); Olaf Brage Marvik, Oslo (NO); Sven-Erik Markhaus Kaiser, Oslo (NO)

(21) Appl. No.: 18/864,446

(22) PCT Filed: May 12, 2023
(86) PCT No.: PCT/EP2023/062848

§ 371 Date: Nov. 8, 2024

(30) Foreign Application Priority Data
May 12, 2022 (NO) 20220564
May 12, 2022 (NO) 20220565
May 12, 2022 (NO) 20220566

(51) Int. Cl. B29D 30/50

(52) U.S. Cl. CPC B29D 30/50

(57) ABSTRACT

A method of providing a join between a first tyre base layer end portion and a second tyre base layer end portion, the method comprising: providing a first length of tyre base layer comprising a first end portion, a first main portion, and a first pair of stiffening elements; providing a second length of tyre base layer comprising a second end portion, second main portion and a second pair of stiffening elements; joining together the first end portion and the second end portion such that each of the stiffening elements of the first pair of stiffening elements align with a corresponding stiffening element of the second pair of stiffening elements.

### TECHNICAL FIELD

The present invention relates to methods and apparatus for providing a join between a first tyre base layer end portion and a second tyre base layer end portion. The present invention may further extend to methods and apparatus for manufacturing a tyre incorporating the methods and apparatus for providing a join between a first tyre base layer end portion and a second tyre base layer end portion.

### BACKGROUND

Tyres (e.g. tyres for vehicles which may be any apparatus for transporting people or cargo) are typically manufactured using a batch process requiring manual labour during intervening steps of the process, as well as during a number of steps of the process itself. For example, bead wires are typically formed into loops for use in the tyre in an initial step, placed by hand onto a loop of tyre base layer material on a drum, and the bead wires then secured within the tyre base layer. A pre-formed strip of rubber to form the tread may then be placed onto the tyre base layer whilst on the drum. The combined loop of tread and tyre base layer is moved to an expanding mold where a curve is added to the flat surface of the loop. The partially shaped tyre may then be placed by hand into individual curing molds for further shaping the tyre and forming the tread pattern during the curing process.

Such batch processes are inefficient in time and cost. It would therefore be beneficial to enable a manufacturing process for tyres with increased efficiency.

### SUMMARY OF THE INVENTION

Viewed from a first aspect, the invention provides a method of providing a join between a first tyre base layer end portion and a second tyre base layer end portion, the method comprising: providing a first length of tyre base layer comprising a first end portion, a first main portion, and a first pair of stiffening elements; providing a second length of tyre base layer comprising a second end portion, second main portion and a second pair of stiffening elements; joining together the first end portion and the second end portion such that each of the stiffening elements of the first pair of stiffening elements align with a corresponding stiffening element of the second pair of stiffening elements.

A tyre base layer is a layer provided beneath the tread of the tyre and which provides a framework to the tyre. In pneumatic tyres where an inner tube or inner liner is present, the base layer covers the inner tube or inner liner to provide protection and to constrain the inner tube or inner liner thereby supporting resistance to internal pressure.

The tyre base layer can comprise any suitable material for use in a base layer of a tyre. For example, a plastic or a metal. Any such material may be provided in a mesh form comprising through surface holes, or in continuous/plate form comprising no through surface holes, i.e. continuous material.

The tyre base layer may comprise a fibre composite and may then be referred to as a tyre carcass.

A stiffening element is any feature that provides a stiffening effect to the tyre base layer. The stiffening element therefore aids in the rigidity of the tyre base layer and aids the tyre base layer's ability to maintain its shape and withstand internal pressure, while the body of the tyre base layer may be a flexible material increasing the toughness of the base layer and assisting the tyre to grip a surface when in use. The stiffening element may be a modified portion of the tyre base layer and therefore integral to the base layer. The stiffening element may be formed of a different material to the material of the tyre base layer and may be embedded in the tyre base layer. For example, the stiffening element may comprise a relatively rigid polymer, such as a polyamide with high tensile strength, and the body of the tyre base layer may comprise a relatively flexible polymer, such as a fibre-reinforced thermoplastic elastomer.

The first and second pair of stiffening elements are thus aligned once the lengths of tyre base layer are connected. The stiffening elements may overlap in the longitudinal and/or lateral direction of the connected tyre bas layers within the area of the join.

The first pair of stiffening elements may comprise a first pair of bead wires and the second pair of stiffening elements comprise a second pair of bead wires.

The stiffening element may be in the form of a bead wire. A bead wire is a length of material akin to a thread in that it extends substantiality in one dimension. A bead wire is not necessarily limited to a metal wire. The bead wire may comprise a metal, a thermoplastic polymer, or a thermoset polymer. The bead wires may comprise a suitable aramid material.

The first length of tyre base layer may be continuous with the second length of tyre base layer, such that the first end portion and second end portion are opposite longitudinal ends of a single tyre base layer.

The complete circular tyre base layer may be formed from a single length of tyre base layer so that one longitudinal end is joined to the other longitudinal end.

Alternatively multiple tyre base layer may be joined at respective longitudinal ends to form a loop.

The method may comprise joining the first end portion to the second end portion via a sleeve, a seam, a weld, a solder and/or a glue.

A sleeve of additional material may be disposed around the join between the first and second end portions and may be tight enough, and/or comprise an adhesive, sufficient to form the join. The sleeve may be applied over a join which may have been created by a weld, a solder and/or a glue.

Joining together the first end portion and the second end portion may comprise: creating a region of contact between the first and second end portions of the tyre base layer; and performing a welding operation to bond the first and second end portions within the region of contact.

The end portions of the tyre base layers are therefore affixed where contact between the two lengths of tyre base layer is created.

The welding operation may comprise one or more of heated tool welding, hot gas welding, ultrasonic welding, spin welding, infrared welding, high frequency welding, vibration welding, induction welding, microwave welding, resistant welding, extrusion welding, and laser welding.

The welding operation may comprise raising the temperature of the region of contact between the first and second end portions and applying pressure for a sufficient length of time to adequately bond the first and second end portions within the region of contact.

The heat may be applied from an external heat source, and/or the heat may be generated by mechanical movement, and/or the heat may be generated using electromagnetism.

The welding operation may comprise vibrating the region of contact between the first and second end portions and applying pressure for a sufficient length of time to adequately bond the first and second end portions within the region of contact. Thus the welding operation may employ friction welding techniques.

The joining together of the first and second lengths of tyre base layer may comprise creating a region of contact between the first and second end portions of the tyre base layer; and the method may comprise: providing a glue within the region of contact and applying pressure to the region of contact.

The end portions of the tyre base layers are therefore affixed where contact between the two lengths of tyre base layer is created.

Creating a region of contact between the first and second end portions of the tyre base layer may comprise placing the first end portion above the second end portion.

The first end portion of the tyre base layer therefore overlaps the second end portion of the tyre base layer. There is thus a double thickness of tyre base layer in the region of contact in the through thickness direction. Thus, if a tyre is formed using the joined tyre base layer, there is additional thickness in the radial direction of the tyre within the region of contact. Extra strength from the increased thickness aids in minimising any reduction in strength caused by the join. Welding and/or gluing can be performed in the overlapped area.

In this case, the first and second pairs of stiffening elements may be aligned such that the first pair overlap the second pair in the through thickness direction. The region of contact can be adequately sized in order to provide sufficient strength to the join and/or to produce a desired length of the combined tyre base layer.

The first end portion may be a first longitudinal face of the first length of tyre base layer, and the second end portion is a second longitudinal face of the second length tyre base layer; and creating a region of contact between the first and second end portions may comprise abutting the first end portion against the second end portion.

By abutting longitudinal end faces there is no overlap of material in the through thickness direction. The end faces of the first pair of stiffening elements may abut the end faces of the second pair of stiffening elements.

The first and second longitudinal ends of the length of tyre base layer may have complementary shapes such that when the first and second end portions of the length of tyre base layer are abutted, a continuous tyre base layer with parallel sides is produced.

Thus, the longitudinal end of the first length of tyre base layer may fit into the adjoining face of the second length of tyre base layer. A smooth transition from the first to the second length of tyre base layer is therefore created and the visibility of the join reduced. The area of contact between the end faces is also maximised by having corresponding shapes that allow continuous contact between the faces.

The first and second longitudinal ends may be either: shaped as a single length perpendicular to the length of tyre base layer; shaped as a plurality of lengths each perpendicular to the length of tyre base layer; shaped as non-perpendicular to the length of tyre base layer; or shaped as a curve, or plurality of curves.

Thus, both ends may be shaped as a straight line along a lateral direction of the tyre base layer. Both ends may be shaped as a straight diagonal line along a direction at an angle to the lateral direction of the tyre base layer. One end may have a stepped or notched shape which may comprise a portion protruding further than another portion and the other end may have an inversely stepped or notched shape which may comprise a portion receptive of the protruding portion of the first end. One end may comprise a concave curve and the other end may comprise an inversely convex curve.

The stiffening elements may extend in a longitudinal direction from the first and/or second end portions of the respective first and second lengths of tyre base layer such that when the contact region is formed the stiffening elements abut and/or overlap.

The respective stiffening elements can connect without interference or overlapping of the tyre base layer material.

The joining together of the first and second end portions may comprise disposing an insert between the longitudinal faces of the first and second lengths of tyre base layers.

Thus, the insert separates at least part of the first end face from the second end face. The insert may be an adhesive to assist with the join. The first and second longitudinal ends can be complementary in shape so as to fit against one another as described above, or the first and second longitudinal ends may have non-complementary shapes and the insert may be shaped so as to ensure the ends are joined such that a continuous tyre base layer with parallel sides is produced.

The insert may comprise a head portion that extends at least partly over the first end portion and second end portions.

Thus, the insert is provided between the end faces as well as above and/or below at least some of the tyre base layer. The additional contact area between the insert and tyre base layer afforded by the head portion increases the strength of the join. The head portion of the insert may extend over the main portion of the first and/or second lengths of tyre base layer.

The stiffening elements may extend in a longitudinal direction from the first and/or second end portions of the respective first and second lengths of tyre base layers such that when the insert is disposed between the longitudinal faces of the first and second lengths of tyre base layers, the stiffening elements abut and/or overlap.

The stiffening elements may therefore extend through the insert. Connection of the stiffening elements may thus occur for improved stress conduction along the tyre base layer.

The stiffening elements of the first pair of stiffening elements may be joined to a corresponding stiffening element of the second pair of stiffening elements via a sleeve, a seam, a weld, a solder or a glue.

The join between stiffening elements may be between the tips of the stiffening elements which overlap in the longitudinal direction, or may be between the sides of ends portions of the stiffening elements which overlap in the lateral or through thickness direction. At least one of the pairs of stiffening elements may extend beyond the base layer material of the respective length of tyre base layer in order to overlap with the corresponding stiffening element of the other pair. In the case that a seam is used to join the stiffening elements, the seam may be formed using such devices as a bar tack machine, or an automatic rope sewing machine.

The stiffening elements may be comprised of a metal and the stiffening elements may be joined via spot welding. The stiffening elements may be comprised of a thermoplastic material and the stiffening elements may be joined by a heat treatment.

The join between the first and second pair of stiffening elements allows for stress to be conducted through the connected pairs. A sleeve of additional material may be disposed around the join of the stiffening elements. The sleeve may be applied over the join which may have been created by a weld, a solder and/or a glue.

The method may comprise bonding a liner material to the first and second lengths of tyre base layers so as to overlap the join between the first and second end portions.

The liner material therefore supports the join. The liner material need not extend around all edges of the tyre base layer but may cover a portion of the join. Optionally, the liner material may be bonded to the first and second lengths of tyre base layer via a glue or adhesive. The liner may extend along the longitudinal length of the tyre base layer by 0.5 cm or more. The liner may extend from one longitudinal face of the tyre base layer to the opposite longitudinal face of the tyre base layer.

The liner material and the first and second lengths of tyre base layer may comprise fibres, and wherein the liner material is bonded to the first and second lengths of tyre base layer such that the fibres of the liner material align with the fibres of the first and second lengths of tyre base layer.

Optionally, the fibres of the liner material may align with the fibres of the first and second lengths of tyre base layer within an angular range of 15 degrees or less. The first and second lengths of tyre base layer may each comprise a first set of fibres and a second set of fibres arranged in two differing angles with respect to the longitudinal length of the tyre base layers, the liner material may comprise two sets of fibres orientated in a corresponding manner to those of the first and second lengths of tyre base layer and the liner material may be bonded to the first and second lengths of tyre base layer such that each of the first and second sets of fibres of the liner material are aligned with the first and second sets of fibres of the lengths of tyre base layers. The fibre's high tensile strength assists in the resistance to tensile stress, aligning the fibres of the liner and tyre base layer allows the stress propagation along the high tensile strength fibres.

The liner material may comprise fibres such that once bonded to the first and second lengths of tyre base layers, the liner material comprises fibres aligned to the longitudinal length of the tyre base layer.

Thus, the liner material comprises fibres aligned with the direction of the stiffening elements in order to assist in the transfer of forces between the stiffening elements of the first and second lengths of tyre base layer.

The liner material may be disposed on a lower surface of the first and second main portions.

That is, when the joined tyre base layer is formed into a cylindrical shape for use in a tyre, the liner is disposed on the radially inner side of the tyre base layer. Differences in height caused by the liner therefore do not affect the tread of the tyre.

The liner material may extend continuously from the lower surface of the first and second main portions, over longitudinal edges of the lengths of base layers and to an upper surface of the first and second lengths of base layer.

Therefore, when the joined tyre base layer is formed into a cylindrical tyre having a double curved shape for use in a tyre, the liner is disposed on a radially inward surface of the tyre base layer relative to a radius r in a lateral cross section and extends to being radially outwardly of the first and second lengths of tyre base layer relative to the radius r in the circumferential plane of the tyre.

The liner material is placed in position over the join prior to joining the first and second end portions.

Thus, in the relevant embodiments, the liner is present when performing the welding operation. Thus, in the relevant embodiments, the liner material is present when raising the temperature of the region of contact between the first and second end portions and applying pressure, and/or present when vibrating the region of contact between the first and second end portions and applying pressure.

The method may comprise performing the method of the first aspect, according to any of the above description, a sufficient number of times to create a circular loop of tyre base layer.

In some cases, the first and second lengths of the tyre base layer are continuous, i.e. belong to a single strip of tyre base layer and the method of joining a first and second end portion need only be performed once in order to form a complete circle of tyre base layer for use in a tyre. In other cases, the first and second lengths of tyre base layer are separate and so that further joins involving the additional end faces are required to form a complete loop for use in a tyre. Many sizes of the first and second lengths of tyre base layer can therefore be used to provide a base layer for a tyre having a desired circumference.

The first and second lengths of tyre base layer may comprise a double curved tyre shape, wherein the double curved tyre shape has a radius r in a lateral cross section and a radius of curvature R in a cross section perpendicular to the lateral cross section.

During the joining operation, the tyre base layer may thus comprise a shape corresponding to the shape it would adopt when in use within a tyre. Alternatively, the tyre base layers can be joined when flat, and later modified to have the double curved tyre shape. The shape of each of the first and second lengths of tyre base layer may comprise a segment of a cylindrical tyre.

The method may comprise applying heat to the tyre base layer and stretching the tyre base layer over the surface of a wheel causing the tyre base layer to adopt a double curved tyre shape.

The heat allows the tyre base layer to become malleable in order to be plastically deformed as it is stretched over the wheel. The tyre base layer is allowed to cool such that the curvature adopted as the tyre base layer is stretched over the wheel is maintained by the tyre base layer.

Stretching the tyre base layer over the wheel may be done in a continuous process so that a continuous belt of tyre base layer may be fed over the wheel and removed from the wheel without cutting the tyre base layer.

Shaping the tyre base layer may reduce the complexity and/or increase the efficiency of further processes to form a tyre with the tyre base layer.

Providing each of the first and second lengths of tyre base layer with a double curved shape may comprise providing a substantially flat shaped length of tyre base layer, wherein the substantially flat shape comprises at least one depression and at least one elevation, wherein each depression and elevation extends and slopes in both a lateral and a longitudinal direction of the tyre base layer.

The substantially flat shape allows for easier processing due to the compact form, for example continuous processing steps are enabled. The method may comprise inverting the depressions to produce the double curved shape having a radius r in a lateral direction and a radius R in a longitudinal direction.

The length of tyre base layer comprising a double curved tyre shape may be manufactured by: providing a length of tyre base layer; inserting the length of tyre base layer within a cavity of a base layer mold; and applying heat and pressure; wherein: the base layer mold is a substantially flat mold comprising a housing comprising at least one longitudinal inner cavity extending between at least two opposing main walls and two opposing edge walls, wherein: each of the main walls has at least one elevation and at least one depression; each elevation and each depression extends and slopes in both a lateral and a longitudinal direction of the cavity; the elevations and depressions are arranged alternately along the length of the mold; and an elevation of one main wall is opposite a depression of the other main wall.

The heat and pressure cause the tyre base layer to adopt the shape of the substantially flat mold.

The length of tyre base layer comprising a double curved tyre shape may be manufactured by: providing a length of tyre base layer; inserting the length of tyre base layer within a cavity of a base layer mold; and applying heat and pressure; wherein: the shape of each of the first and second lengths of tyre base layer comprises a segment of cylindrical tyre.

The shape of the cavity of the tyre base layer mold may correspond to a segment of a circle. The segment may be a 45-degree segment or less, may be a 45 degree segment or more, a 90 degree segment or more, may be a 180 degree segment (i.e. a semicircle) or more, may be a 270 degree segment or more.

The shape of the cavity of the tyre base layer mold may comprise a plurality of segments of a cylindrical tyre. The arc of each of the plurality of segments may extend along the longitudinal length of the cavity and the midpoints of at least one pair of adjacent segments may extend in the same transverse direction relative to the longitudinal length of the cavity, thereby forming a bump-like pattern.

Additionally or alternatively, the arc of each of the plurality of segments may extends along the longitudinal length of the cavity and the midpoints of at least one pair of adjacent segments extend in opposite transverse directions relative to the longitudinal length of the cavity, thereby forming a sine wave-like pattern. The mold therefore reduces the dimensions and complexity of the mold by flattening the mold in respect of the curve with radius R in a cross section perpendicular to the longitudinal direction of the cylindrical tyre.

The first and/or second length of tyre base layer may comprise a tread.

Tread on the first length of tyre base layer may be joined to tread on the second length of tyre base layer which may be achieved using the joining process that joins the tyre base layer. Alternatively, an additional step may be required to join the treads.

The tread may be an overmolded tread, that is, the tread may have been disposed on the first and second lengths of tyre base layer via injection molding prior to the joining step being performed.

The tread may be an overmolded tread and may be provided by; inserting a length of the tyre base layer into a tread mold; injecting an elastomeric material into the tread mold; allowing the elastomeric material to set in order that the elastomeric material and tyre base layer adopt the shape of the tread mold; and removing the bonded tyre base layer and elastomeric material from the tread mold.

The tread mold may be a substantially flat tread mold comprising a housing comprising at least one longitudinal inner cavity extending between at least two opposing main walls and two opposing edge walls, wherein: each of the main walls has at least one elevation and at least one depression; each elevation and each depression extends and slopes in both a lateral and a longitudinal direction of the cavity; the elevations and depressions are arranged alternately along the length of the tread mold; and an elevation of one main wall is opposite a depression of the other main wall.

The joining process may be performed whilst the tyre base layer and overmolded tread are in the substantially flat shape. Alternatively, the method may comprise providing overmolded tread on the tyre base layer using the substantially flat tread mold as described above, and inverting the depressions to produce the double curved shape having a radius r in a lateral direction and a radius R in a longitudinal direction prior to joining the first and second length of tyre base layer.

The first and/or second length of tyre base layer may be provided with a double curved shape, wherein the dimensions of the depressions and elevations of the tyre base layer are greater than the dimensions of the depressions and elevations of the tread mould.

Thus, when a substantially flat tyre base layer and a substantially flat tread mold are used, the dimensions differ between the molds such that the dimensions of the shaped tyre base layer are larger than the equivalent dimensions of the shaped tread. Due to the difference in thermal expansions of the material of the tyre base layer and the thermal expansion of the tread material, following the deposition of the tread onto the base layer and subsequent cooling the curvature of the base layer and tread will align. Thus differences in thermal expansion of different materials is accounted for.

The shape of a cavity of the tread mould may comprise at least one segment of a cylindrical tyre.

The shape of the cavity of the tread mold may correspond to a segment of a circle. The segment may be a 45-degree segment or less, may be a 45 degree segment or more, a 90 degree segment or more, may be a 180 degree segment (i.e. a semicircle) or more, may be a 270 degree segment or more.

The shape of the cavity of the tread mold may comprise a plurality of segments of a cylindrical tyre. The arc of each of the plurality of segments may extend along the longitudinal length of the cavity of the tread mold and the midpoints of at least one pair of adjacent segments may extend in the same transverse direction relative to the longitudinal length of the cavity, thereby forming a bump-like pattern. Additionally or alternatively, the arc of each of the plurality of segments may extends along the longitudinal length of the cavity of the tread mold and the midpoints of at least one pair of adjacent segments extend in opposite transverse directions relative to the longitudinal length of the cavity, thereby forming a sine wave-like pattern. The tread mold therefore reduces the dimensions and complexity of the tread mold by flattening the mold in respect of the curve with radius R in a cross section perpendicular to the longitudinal direction of the cylindrical tyre.

The first and second lengths of tyre base layer may be provided with a double curved tyre shape and the radius of curvature adopted by the first and second lengths of tyre base layer may be larger than the radius of curvature of the cavity of the tread mould.

Thus, the radius of curvature of the first and second lengths of tyre base layer is greater than the radius of curvature of the at least one segment of the tread mould. That is to say, the transverse and longitudinal extents of the at least one segment of the tyre base layers are greater than the transverse and longitudinal extents of the at least one segments in the tread mold. Therefore, the at least one segment of the tyre base layer has larger dimensions than the at least one segment of the tread mould into which it is inserted.

The first end portion, the first main portion and the second main portion may comprise a tread and the second end portion does not comprise a tread, and the joining of the first end portion and second end portion may comprise joining the tread of the first end portion to the tread of the second main portion, and/or joining the tread of the first end portion to the tyre base layer of the second end portion.

The base layer of the second end portion may overlap the first end portion so that the tread of the second main portion is adjacent or abuts the tread of the first end portion. The treads may be joined by overmolding further elastomeric material onto exposed tyre base layer of the first end portion. Alternatively, the treads may be joined by any of the joining process discussed above in relation to the joining of the tyre base layer.

The tread of the first end portion may extend beyond the tyre base layer of the first end portion in the longitudinal direction of the tyre base layer.

The tread extending beyond the tyre base layer of the first end portion may be bonded to the base layer of the second end portion. The tread may extend beyond the tyre base layer by 1 cm or more. The tread may extend beyond the tyre base layer by up to 5 cm. When an insert is used, the tread of the first end portion may extend beyond the insert. The tread extending beyond the base layer of the first end portion and/or the insert may have a length such that the treads of the first and second end portions are able to be joined and the tyre base layers of the first and second end portions are able to be joined.

The first main portion and the second main portion may comprise a tread and the first end portion and the second end portion may not comprise a tread, and the joining of the first end portion and second end portion may comprise at least partly overlapping the first and second end portions, applying a material between the first and second main portions so as to cover the first and second end portions.

The material applied between the first and second main portions may be applied by overmolding elastomeric material onto exposed tyre base layer. The material applied between the first and second main portions may penetrate the tyre base layer such that elastomeric material extends from one face of the tyre base layers of the first and second end portions to the opposite face of the first and second tyre end portions. Particularly good penetration occurs when the tyre base layer is comprised of a mesh and/or a fabric.

The first and second lengths of tyre base layer may each be provided by: providing a sheet of material having a first lateral edge portion, and a second lateral edge portion, wherein the first lateral edge portion is separated from the second lateral edge portion by a central portion, laying a first stiffening element on the sheet where the first lateral edge portion and central portion meet, and laying a second bead wire on the sheet where the central portion and second lateral edge portion meet, folding the first lateral edge portion over the first stiffening element,
folding the second lateral edge portion over the second stiffening element, and securing the first lateral edge portion and the second lateral edge portion to the central portion.

The method enables a base layer comprising a stiffening element to be formed in a continuous process. The base layer comprising a stiffening element may be formed in a flat piece which need not be provided with a length commensurate with the circumference of a tyre. Instead using the above method, a long length of base layer can be produced with a length many times the circumference of a tyre which can cut to an appropriate size on demand. Providing a continuous belt of base layer allows the base layer to be incorporated into a continuous process for forming a tyre.

The first and or second lengths of base layer may be provided in the form of a continuous belt of tyre base layer.

The joining of the two base layer end portions can thus be incorporated in to a continuous manufacturing process.

Viewed from another aspect, the invention provides a tyre manufactured according to the method for manufacturing the tyre base layer and overmolded tread described above.

The tyre may be suitable for any transport apparatus comprising a wheel. The tyre may be suitable for a bicycle or tricycle, a motor vehicle such as a car motorbike, scooter and lorry, or a pram or the like.

Viewed from another aspect, the invention provides an apparatus for joining a first length of tyre base layer and a second length of tyre base layer, the apparatus comprising a clamp for positioning a first end portion of a first length of tyre base layer and a second end portion of a second length of tyre base layer, and for performing a welding operation to bond the first and second end portions.

Thus, in relevant embodiments, the apparatus for joining a first length of tyre base layer and a second length of tyre base layer is configured to apply pressure and one or more of heat and vibration to the first and second end portions. The heat may be applied from an external heat source, and/or the heat may be generated by mechanical movement, and/or the heat may be generated using electromagnetism.

The apparatus may comprise a means for cutting a continuous belt of tyre base layer into a desired length for the first and/or second length of tyre base layer.

The apparatus may comprise an overmolding station comprising a means for simultaneously positioning the first and second end portions of the tyre base layers in an at least partly overlapped configuration, and for injecting an elastomeric material between the first and second main portions of the tyre base layers.

### BRIEF DESCRIPTION OF THE DRAWINGS

Certain embodiments of the invention will now be described by way of example only and with reference to the accompanying drawings in which:

FIG. 1 shows a sheet of tyre base layer material and stiffening elements, the sheet and stiffening elements may continue in length beyond the dimensions indicated in the figure

FIG. 2a shows a tyre base layer comprising stiffening elements

FIG. 2b shows a tyre base layer comprising stiffening elements

FIG. 3a shows an apparatus for forming a tyre base layer comprising stiffening elements

FIG. 3b shows an apparatus for providing components for forming a tyre base layer comprising stiffening elements

FIG. 3c shows a spool onto which a belt of continuous tyre base layer comprising stiffening elements is rolled

FIG. 4 shows a sheet of tyre base layer material and stiffening elements, the sheet and stiffening elements may continue in length beyond the dimensions indicated in the figure

FIG. 5 shows a tyre base layer comprising stiffening elements

FIG. 6a shows a cross section through the longitudinal length of a continuous belt of tyre base layer comprising stiffening elements

FIG. 6b shows a cross section through the longitudinal length of a continuous belt of tyre base layer comprising stiffening elements

FIG. 7a shows a cross section through the longitudinal length of a continuous belt of tyre base layer comprising stiffening elements and a puncture protection layer

FIG. 7b shows a cross section through the longitudinal length of a continuous belt of tyre base layer comprising stiffening elements and a puncture protection layer

FIG. 7c shows a cross section through the longitudinal length of a continuous belt of tyre base layer comprising stiffening elements and a puncture protection layer

FIG. 8 shows an apparatus for providing a puncture protection layer for forming a continuous belt of tyre base layer comprising stiffening elements and a puncture protection layer

FIG. 9 shows a tubular material and stiffening elements for forming a tyre base layer, the tubular material and stiffening elements may continue in length beyond the dimensions indicated in the figure

FIG. 10 shows a tyre base layer comprising stiffening elements comprising a tubular material, the tyre base layer comprising stiffening elements may continue in length beyond the dimensions indicated in the figure

FIG. 11 shows a cross section through the longitudinal length of a continuous belt of tyre base layer comprising stiffening elements

FIG. 12a shows a cross section through the longitudinal length of a continuous belt of tyre base layer comprising stiffening elements and a puncture protection layer

FIG. 12b shows a cross section through the longitudinal length of a continuous belt of tyre base layer comprising stiffening elements and a puncture protection layer

FIG. 12c shows a cross section through the longitudinal length of a continuous belt of tyre base layer comprising stiffening elements and a puncture protection layer

FIG. 13 shows a tyre base layer comprising stiffening elements shaped as a segment of a double curved tyre shape

FIG. 14 shows an apparatus for shaping the tyre base layer and stiffening elements

FIG. 15 shows a segment mold for shaping the tyre base layer and stiffening elements

FIG. 16 shows a segment of a tyre base layer and stiffening element shaped using the segment mold of FIG. 15

FIG. 17 shows a segment mold for shaping the tyre base layer and stiffening elements

FIG. 18 shows a cross section through the longitudinally extending centre line of a substantially flat mold for shaping the tyre base layer comprising stiffening elements

FIG. 19 shows the lower half of a substantially flat mold for shaping the tyre base layer comprising stiffening elements

FIG. 20 shows a contour map of the substantially flat shape

FIG. 21 shows a tyre base layer comprising stiffening elements comprising the substantially flat shape

FIG. 22 shows a tyre base layer comprising stiffening elements and an overmolded tread

FIG. 23 shows an apparatus for manufacturing a continuous belt of tyre base layer comprising stiffening elements and overmolded tread

FIG. 24 shows a cross section through the longitudinally extending centre line of a substantially flat mold for overmolding tread to a tyre base layer comprising stiffening elements

FIG. 25 shows a tyre base layer comprising stiffening elements comprising an overmolded tread and comprising the substantially flat shape

FIG. 26 shows a segment mold for overmolding a tread to a tyre base layer comprising stiffening elements

FIG. 27 shows a tyre base layer comprising stiffening elements comprising an overmolded tread, comprising a double curved tyre shape and formed using the mold of FIG. 26

FIG. 28 shows a segment mold for overmolding a tread to a tyre base layer comprising stiffening elements

FIG. 29 shows a tyre base layer comprising stiffening elements comprising an overmolded tread, comprising a double curved tyre shape and formed using the mold of FIG. 28

FIG. 30 shows a substantially flat tread mold and a pre-shaped tyre base layer comprising stiffening elements

FIG. 31 shows two lengths of tyre base layer comprising stiffening elements

FIG. 32 shows two lengths of tyre base layer comprising stiffening elements each comprising a double curved shape

FIG. 33 shows a complete loop of tyre base layer formed by joining the ends of a single strip tyre base layer comprising stiffening elements

FIG. 34 shows a complete loop of tyre base layer formed by joining multiple strips of tyre base layer comprising stiffening elements

FIG. 35 shows a contact region between two lengths of tyre base layer

FIG. 36 shows a contact region between two lengths of tyre base layer

FIG. 37 shows the end portions of two lengths of tyre base layer

FIG. 38 shows the contact region between the two lengths of tyre base layer shown in FIG. 37, and a piece indicating the overmolded material to be added to the partly overlapped end portions

FIGS. 39a to 39d show plan views of configurations for the end portions of the lengths of the tyre base layer

FIGS. 40a to 40c show transverse views of two lengths of tyre base layer joined using an insert

FIG. 41a shows a lateral view of two lengths of tyre base layer joined using an insert, shown in expanded form

FIGS. 41b and 41c show a plan view of two lengths of tyre base layer joined using an insert

FIG. 42a shows a lateral view of two flat lengths of tyre base layer joined and comprising a liner material

FIG. 42b shows two lengths of tyre base layer comprising a double curved shape joined and comprising a liner material

FIG. 42c shows an expanded view of FIG. 42b

FIG. 43 shows two lengths of tyre base layers to be joined comprising fibres, and a liner material comprising fibres

FIG. 44a shows two lengths of tyre base layers comprising stiffening elements and a tread to be joined

FIG. 44b shows two lengths of tyre base layer comprising stiffening elements and a tread to be joined

FIG. 45 shows an apparatus for joining a first and second length of tyre base layer comprising stiffening elements together.

### DETAILED DESCRIPTION

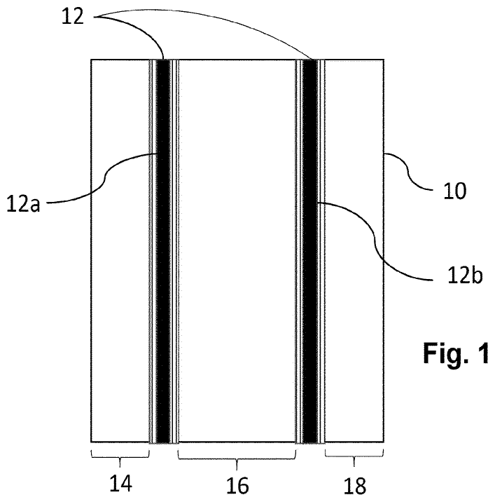

As seen in FIG. 1, a pair of bead wires 12 are positioned onto a sheet of base layer material 10 and each are aligned with the longitudinal length of the sheet 10. The sheet 10 thus comprises a first lateral edge portion 14, a central portion 16 and a second lateral edge portion 18 delimited by the bead wires 12.

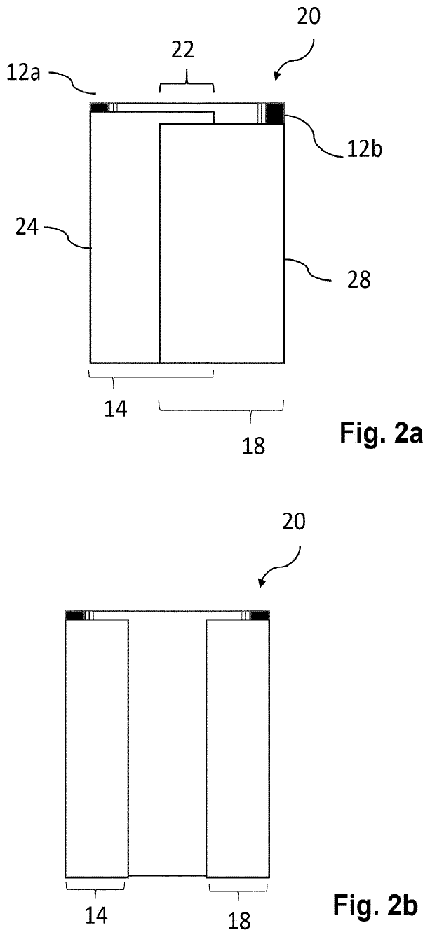

FIG. 2a shows the sheet of tyre base layer material having been formed in to a tyre base layer comprising stiffening elements by folding the first lateral edge portion 14 over the first bead wire 12a and the second lateral edge portion 18 over the second bead wire 12b. The first lateral edge portion 14 and the second lateral edge portion 18 overlap to form an overlapped area 22. The first and second lateral edge portions 14, 18 can be secured to the central portion 16. In the overlapped area 22 the first and second lateral edge portions 14, 18 can also be secured to each other. Since the pair of bead wires 12 are positioned parallel to one another, the first longitudinal side 24 and the second longitudinal side 28 of the tyre base layer comprising stiffening elements 20 are also parallel to one another. The first lateral edge portion 14 and the second lateral edge portion 18 need not overlap to form an overlapped area 22; FIG. 2b illustrates an example in which the first and second lateral edge portions 14, 18 are secured to the central portion only.

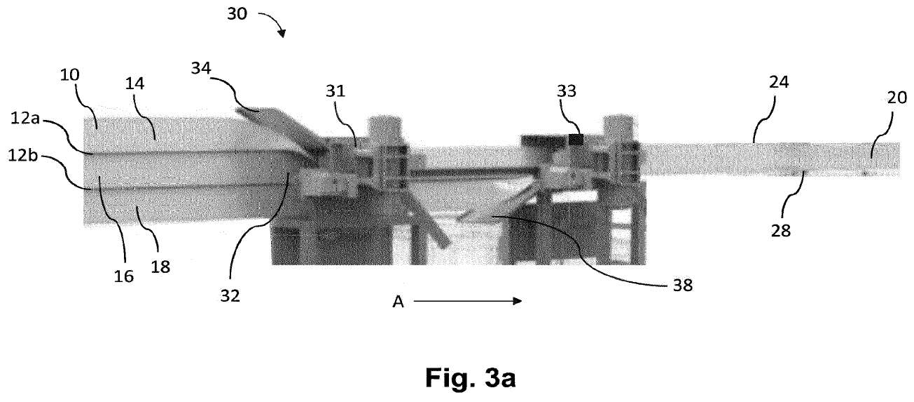

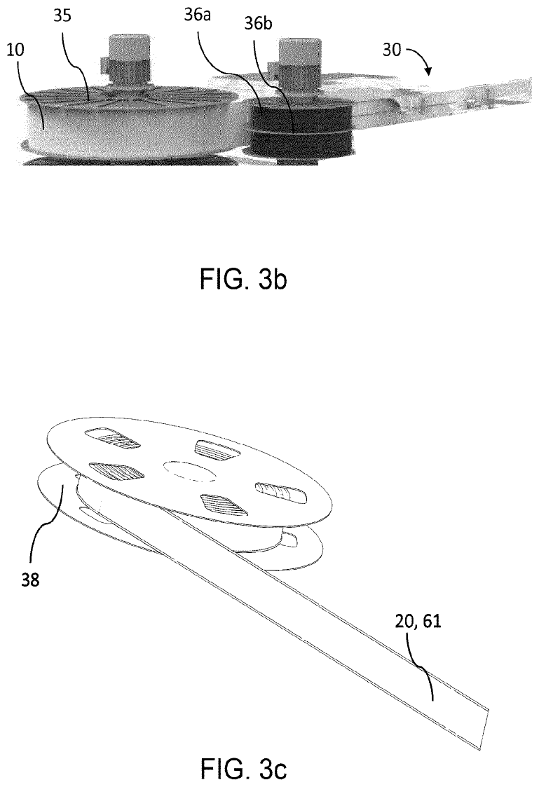

FIG. 3a shows the folding of the sheet of base layer material 10 being carried out by a folding apparatus 30. The relevant reference numerals as provided in FIGS. 1 and 2 have been reproduced in FIG. 3a. A sheet of base layer material 20 is fed into the folding apparatus 30 at a first end 32 and is moved along the folding apparatus 30 in direction A. A first folding device 31 comprises a first folding guide 34. The first folding guide 34 urges the first lateral edge portion 14 to bend, or fold, around the first bead wire 12a and guides the first lateral edge portion 14 into position adjacent or in contact with the central portion 16. Further along the folding apparatus 30, in direction A, a second folding device 33 is provided. The second folding device 33 comprises a second folding guide 38 which urges the second lateral edge portion 18 to bend, or fold, around the second bead wire 12b and guides the second lateral edge portion 18 into position adjacent or in contact with the central portion 16, and/or adjacent or in contact with the first lateral edge portion 14 in an overlapped area 22.

As the sheet of base layer material 20 is fed through the folding apparatus 30, the creation of the tyre base layer comprising stiffening elements 20 can be performed continuously. In this way, a continuous belt of tyre base layer can be formed. This means tyre base layer comprising stiffening elements 20 sufficient for use is multiple tyres can be formed without manual intervention. The tyre base layer comprising stiffening elements 20 that exits the second folding device 33 can be rolled onto a spool for storage.

The first folding device 31 also comprises a securing means, not shown, in order to secure the first lateral edge portion 14 to the central portion 16. Likewise, the second folding device 33 comprises a securing means, not shown, to secure the second lateral edge portion 18 to the central portion 16 and/or first lateral edge portion 14. For example, the securing means of the first and/or second folding device 31, 33 may comprise a heat gun.

FIG. 3b shows a base layer material spool 35, a first bead wire spool 36a and a second bead wire spool 36b. A sheet of base layer material 10 is fed directly from the base layer material spool 35 to an assembly unit comprising the folding apparatus 30. Likewise first and second bead wires 12a and 12b are fed directly from the first and second bead wire spools 36a, 36b respectively to the folding apparatus 30. A fixing device, not shown, can be used to secure the bead wires 12a, 12b in position on the sheet of base layer material prior to the folding operation beginning.

FIG. 3c shows an assembled tyre base layer comprising stiffening elements 20, 61 being rolled onto a spool 38 for storage. The tyre base layer comprising stiffening elements 20 may be rolled on to the spool 38 directly from the folding apparatus 30 or after further manufacturing steps such as the application of an overmolded as described below. The tyre base layer comprising stiffening elements 61 formed using a tubular material, described further below, can also be rolled onto a spool 38 directly after it is assembled, or after further manufacturing steps also.

The continuous belt of tyre base layer comprising stiffening elements 20 can be drawn from the spool and cut into lengths desirable for further processing for use in a tyre. The continuous belt of tyre base layer comprising stiffening elements 20 can be drawn directly from the spool into a further device for processing the continuous belt of tyre base layer comprising stiffening elements 20 for use in a tyre. In this way the processing can remain continuous.

The continuous belt of tyre base layer comprising stiffening elements 20 can instead be fed directly from the folding apparatus 30 to a further device for processing the continuous belt of tyre base layer comprising stiffening elements 20 for use in a tyre. Similarly, in this way the processing can remain continuous.

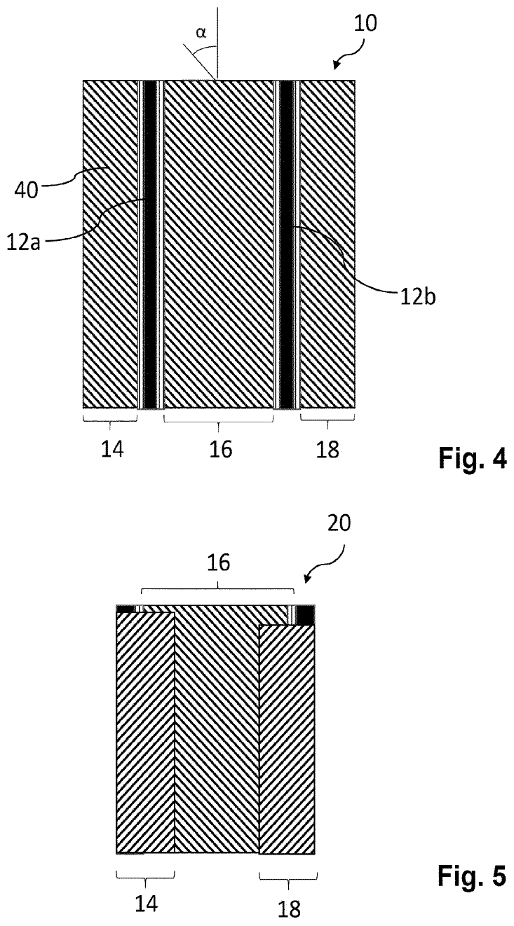

FIG. 4 shows the sheet of material 10 comprising a fibre structure. The fibres of the fibre structure may be formed of nylon, cotton, polyester, or aramid. The fibre structure comprises a unidirectional set of fibres 40 (the diagonal hatching indicating the presence and direction of the first set of fibres), wherein each fibre in the set 40 extends in a direction approximately parallel the other fibres in the set 40. The unidirectional set of fibres 40 are supported by a support set of fibres, not shown, that are weaved through the unidirectional set of fibres 40 to secure the fibres relative to one another.

The sheet of material 10 is cut such that the direction of the unidirectional set of fibres 40 is misaligned by an angle a to the longitudinal direction of the sheet.

FIG. 5 shows the tyre base layer comprising stiffening elements 20 once the first lateral edge portion 14 is folded over the first bead wire 12a and the second lateral edge portion 16 is folded over the second bead wire 12b. As illustrated by the hatching, the direction of the unidirectional set of fibres 40 in the central potion 16 will differ from the direction of the unidirectional set of fibres in the first and second lateral edge portions. Put another way, the base layer material provided between the pair of bead wires 12 in the tyre base layer comprising stiffening elements 20 will comprise fibres of differing directions.

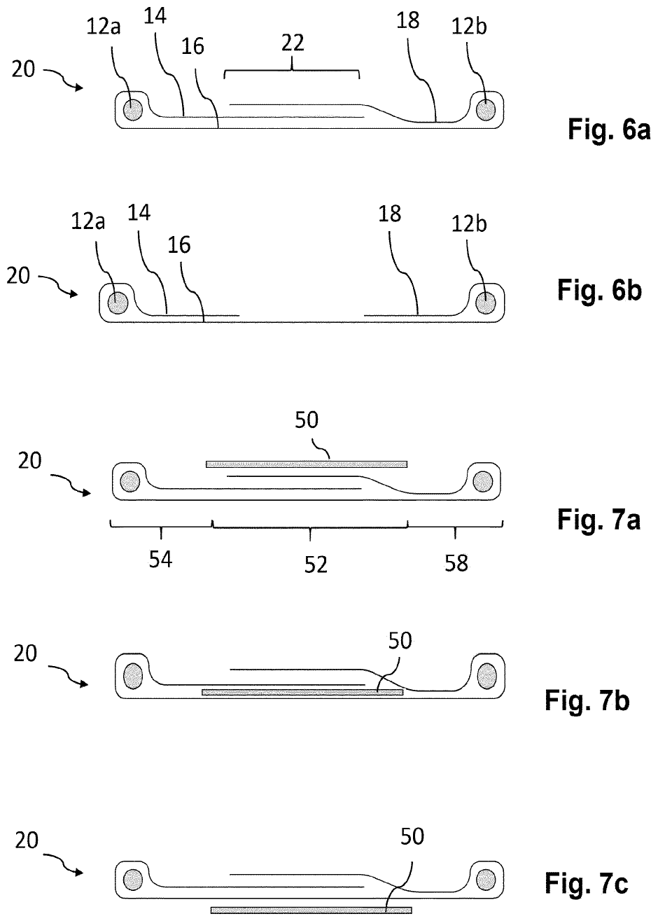

FIG. 6a shows a cross section of the tyre base layer comprising stiffening elements 20 taken perpendicular to its longitudinal length. The first lateral edge portion 14 is folded around the first bead wire 12a and secured to the central portion 16. The second lateral edge portion is folded around the second bead wire 12b and secured to the central portion 16 as well as the first lateral portion 14 in the over lapped area 22.

FIG. 6b shows a similar cross section to FIG. 6a for the example in which the first and second lateral ends 14, 18 do not form an overlapped area 22.

FIGS. 7a to 7c similarly show a cross section of the tyre base layer comprising stiffening elements 20 taken perpendicular to its longitudinal length. Each of FIGS. 7a to 7c show a puncture protection layer 50. In each case the puncture protection layer 50 is provided at a middle portion 52 of the tyre base layer comprising stiffening elements 20. When the tyre base layer is used within a tyre, the middle portion 52 of the tyre base layer comprising stiffening elements 20 will coincide with the tread of the tyre, and the first and second side portions 54, 58 of the tyre base layer comprising stiffening elements 20 will coincide with the side walls of the tyre. The middle portion 52 will be positioned adjacent the ground contacting area of the tyre. The puncture protection layer 50 is thus positioned to at least coincide with the tread of a tyre to provide the most useful protection.

FIG. 7a illustrates the puncture protection layer 50 being provided on an outer surface of the first and/or second lateral portions 14, 18.

FIG. 7b illustrates the puncture protection layer 50 being provided between the central portion 16 and the first and/or second lateral portions 14, 18.

FIG. 7c illustrates the puncture protection layer 50 being provided on an outer surface of the central portion 16.

The puncture protection layer 50 can be provided in corresponding positions as in FIGS. 7a-7c for the example in which the first and second lateral ends 14, 18 do not form an overlapped area 22 as in FIG. 6b.

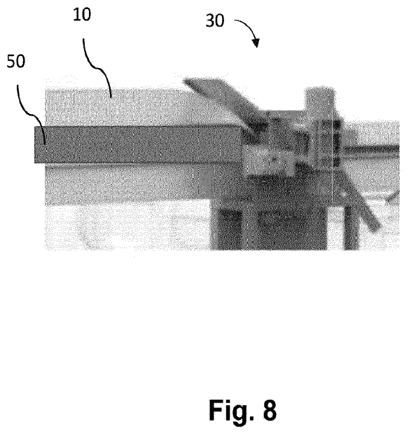

FIG. 8 shows the puncture protection layer 50 being provided to the folding apparatus 30. In this example, the puncture protection layer can be incorporated between an overlapped portion of the sheet of base layer material, or secured to the sheet 10 using the steps described herein.

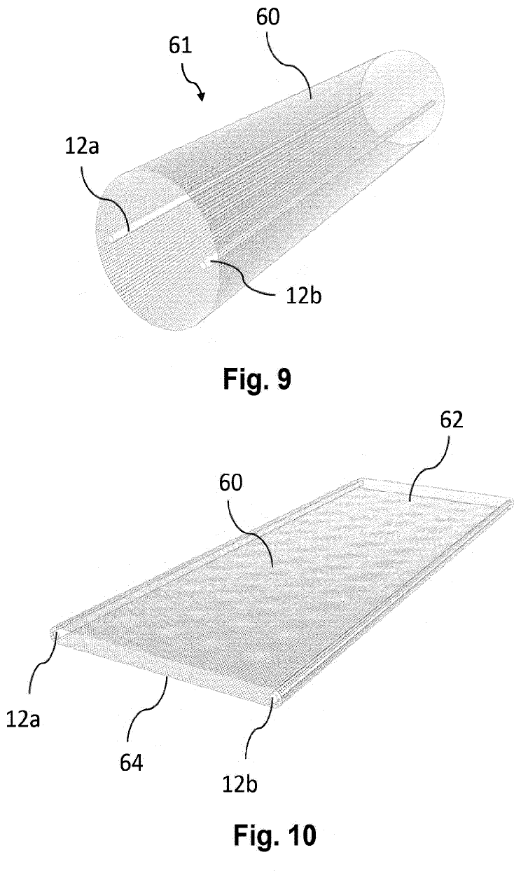

FIG. 9 shows a tubular material 60 used for manufacturing a continuous belt of tyre base layer. The tubular material 60 extends in a longitudinal direction and during manufacturing of the continuous belt of tyre base layer, first and second stiffening elements 12a, 12b are inserted into the tubular material 60 so as to extend in the same longitudinal direction. The first and second stiffening elements 12a, 12b therefore extend parallel to the longitudinal length of the tubular material 60. By tubular it is meant that the material provides a cylinder comprising a hollow centre, thus the stiffening elements 12a, 12b are inserted into the hollow centre. The tube configuration of the tubular material may be created at the same time as the stiffening elements are inserted into the centre of the tubular material (such as by securing a first longitudinally extending edge portion to a second longitudinally extending edge portion or by weaving the material) so as to enable continuous production of the tyre base layer comprising stiffening elements 61.

FIG. 10 shows the tubular material once flattened. To maintain the flattened shape, the tubular material on a first side 62 of (e.g. above) the first and second stiffening elements 12a, 12b is secured to the tubular material on a second side 64 (e.g. below) the first and second stiffening elements. The first side 62 and second side 64 are on opposite sides of the stiffening elements 12a, 12b.

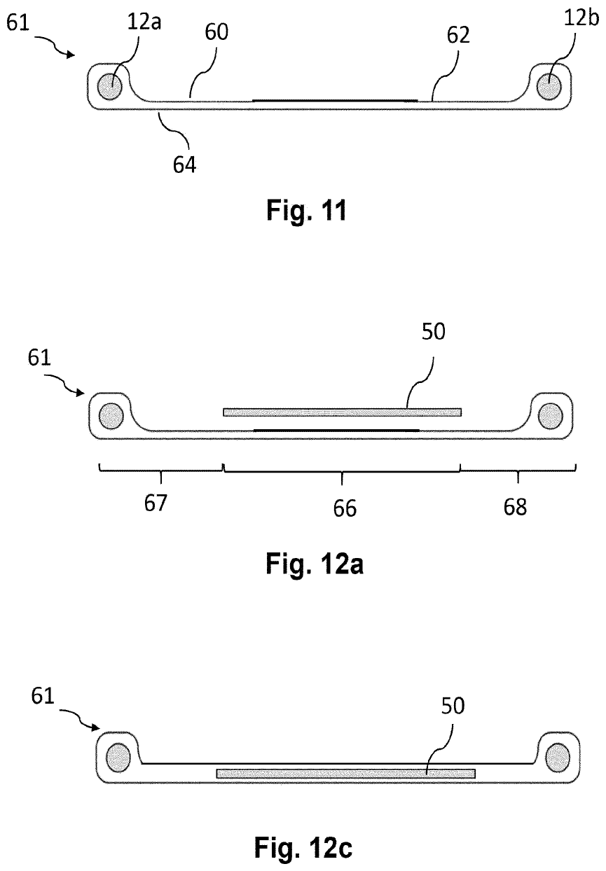

FIG. 11 shows a cross section of the tyre base layer comprising stiffening elements 61 taken perpendicular to its longitudinal length. The tubular material on a first side 62 of (e.g. above) the first and second stiffening elements 12a, 12b is secured to the tubular material on a second side 64 (e.g. below) the first and second stiffening elements.

FIGS. 12a and 12b similarly show a cross section of the tyre base layer comprising stiffening elements 61 taken perpendicular to its longitudinal length. Each of FIGS. 12a and 12b show a puncture protection layer 50. In each case the puncture protection layer 50 is provided at a middle portion 66 of the tubular tyre base layer comprising stiffening elements 61. When the tyre base layer is used within a tyre, the middle portion 66 of the tyre base layer comprising stiffening elements 61 will coincide with the tread of the tyre, and first and second side portions 67, 68 of the tyre base layer comprising stiffening elements 61 will coincide with the side walls of the tyre. The middle portion 66 will be positioned adjacent the ground contacting area of the tyre. The puncture protection layer 50 is thus positioned to at least coincide with the tread of a tyre to provide the most useful protection.

FIG. 12a illustrates the puncture protection layer 50 disposed on the radially outer side of the tubular material 60 as viewed in cross section perpendicular to the longitudinal length of the tubular material. The puncture protection layer 50 can be secured to the belt of tyre base layer in a continuous manner. In a later step, tread may be applied such that the puncture protection layer is between the tread and the tyre base layer, or tread may be applied such that the tyre base layer is between the puncture protection layer 50 and the tread.

FIG. 12b illustrates the puncture protection layer 50 disposed radially inner side of the tubular material as viewed in cross section perpendicular to the longitudinal length of the tubular material. The puncture protection layer can be inserted into the hollow of the tubular material as the tube configuration is created (such as by securing a first longitudinally extending edge portion to a second longitudinally extending edge portion or by weaving the material) so as to enable continuous production of the tyre base layer comprising stiffening elements 20 and puncture protection layer.

The creation of the tyre base layer comprising stiffening elements 61 can be performed continuously. In this way, a continuous belt of tyre base layer can be formed. This means tyre base layer comprising stiffening elements 61 sufficient for use is multiple tyres can be formed without manual intervention. The tyre base layer comprising stiffening elements 61 can be rolled onto a spool for storage. The continuous belt of tyre base layer comprising stiffening elements 61 can be drawn from the spool and cut into lengths desirable for further processing for use in a tyre. The continuous belt of tyre base layer comprising stiffening elements 61 can be drawn directly from the spool into a further device for processing the continuous belt of tyre base layer comprising stiffening elements 61 for use in a tyre. In this way the processing can remain continuous.

In some examples the continuous belt of tyre base layer preform is further processed in order to alter the shape of the tyre base layer comprising stiffening elements 20, 61. The shape is modified to more closely match the shape the tyre base layer will have when it is used within a tyre.

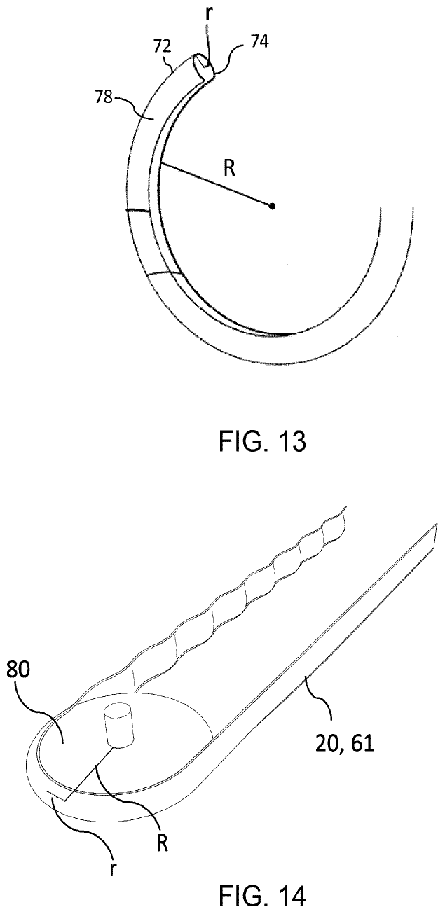

The modified shape will therefore have at least some curved aspect reflecting the double curved tyre shape shown in FIG. 13. The double curve tyre shape comprises a curvature having a radius of curvature r in a lateral cross section and a curvature having a radius of curvature R in a cross section perpendicular to the longitudinal cross section of the cylindrical tyre. The double curved tyre shape can also be described as an annular segment having an omega “Ω” cross section.

The tyre base layer having a double curved shape will comprise a first side wall 74 comprising the first side portion of the tyre base layer 54, 67 and a second side wall 78 comprising the second side portion of the tyre base layer 58, 68. The side walls 74, 78 extend approximately radially and circumferentially about radius of curvature R. The middle portion of the base layer 52, 66 will form an approximately circumferentially and axially extending middle wall 72 about radius of curvature R.

The dimensions of the curvature of the tyre base layer need not match the dimensions of the curvature of the tyre and/or the curvature that the base layer will adopt in the final tyre. The curvature provided to the tyre base layer comprising stiffening elements 20, 61 may be smaller than that of the final curvature in order to introduce a degree of the shaping prior to assembly into a tyre, or the curvature provided to the tyre base layer comprising the stiffening elements may be larger than the final curvature in order to compensate for shrinkage that may occur in further processing to assemble the tyre.

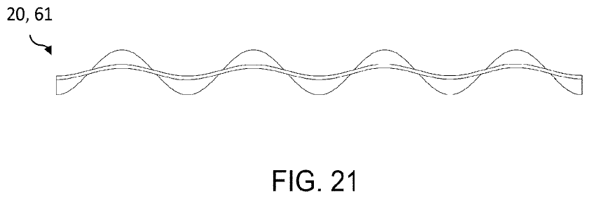

A wheel 80 can be used to shape the tyre base layer comprising stiffening elements 20, 61. The tyre base layer comprising stiffening elements 20, 61 is stretched over the surface of the wheel 80 and heat is applied causing the tyre base layer comprising stiffening elements 20, 61 to adopt a curvature. As shown in FIG. 14 the surface of the wheel 80 has a radius of curvature r in a lateral cross section and a radius of curvature R in a cross section perpendicular to the lateral cross section, thus the tyre base layer comprising stiffening elements 20, 61 stretched over this wheel adopts a double curved tyre shape. The resultingly shaped tyre base layer comprising stiffening elements 20, 61 can be manipulated into a substantially flat shape for ease of further use by inverting portions of the tyre base layer comprising stiffening elements 20, 61 to create depressions and elevations in the longitudinal and transverse direction such as those that can be seen in FIG. 21.

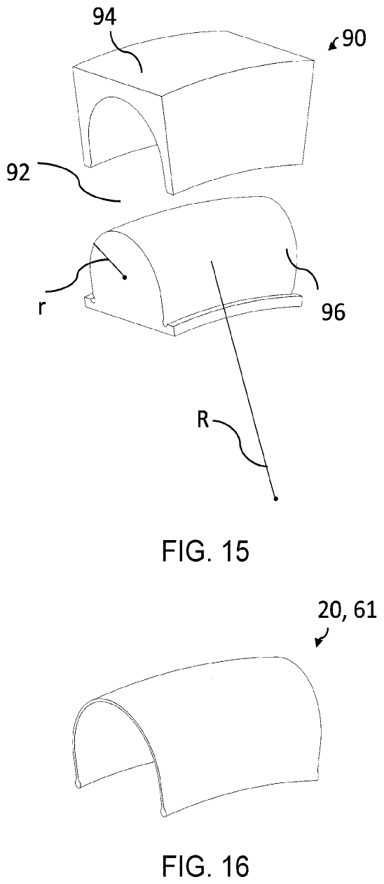

The tyre base layer comprising stiffening elements 20, 61 can be shaped into a double curve tyre shape using a segment mold 90 which comprises a cavity 92 comprising at least a segment of the double curved tyre shape. Such a segment mold 90 is shown in FIG. 15. Tyre base layer comprising stiffening elements 20, 61 can be provided as a belt of continuous tyre base layer and drawn into the cavity 92, the upper and lower parts 94, 96 of the segment mold close in order to compress the tyre base layer comprising stiffening elements 20, 61 within the cavity 92 and heat and pressure is applied.

The shaped tyre base layer that is obtained following shaping using this segment mold 90 is shown in FIG. 16. The cavity 92 and the shaped tyre base layer has a curvature r in the transverse cross section and a radius R in a cross section perpendicular to the transverse cross section.

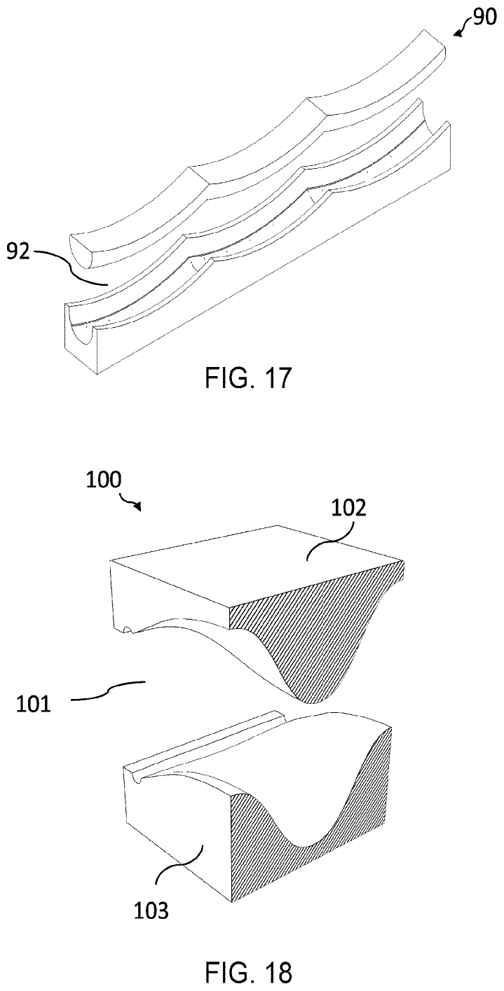

An alternative segment mold 90 is shown in FIG. 17 wherein the cavity 92 comprises a plurality of segments. The shaped tyre base layer comprising stiffening elements resulting from this mold can be further manipulated (e.g. bent or stretched) in order to remove joins between segments and to form a continuous curvature.

FIG. 18 shows a cross section (cut through the centre of the mould) of a substantially flat tyre base layer mold 100 used for pre-shaping the tyre base layer comprising the stiffening elements 20, 61. The cavity 101 created between the top piece 102 and the bottom piece 103 comprises depressions and elevations which extend in a transverse direction of the cavity 101 and a longitudinal direction of the cavity 101.

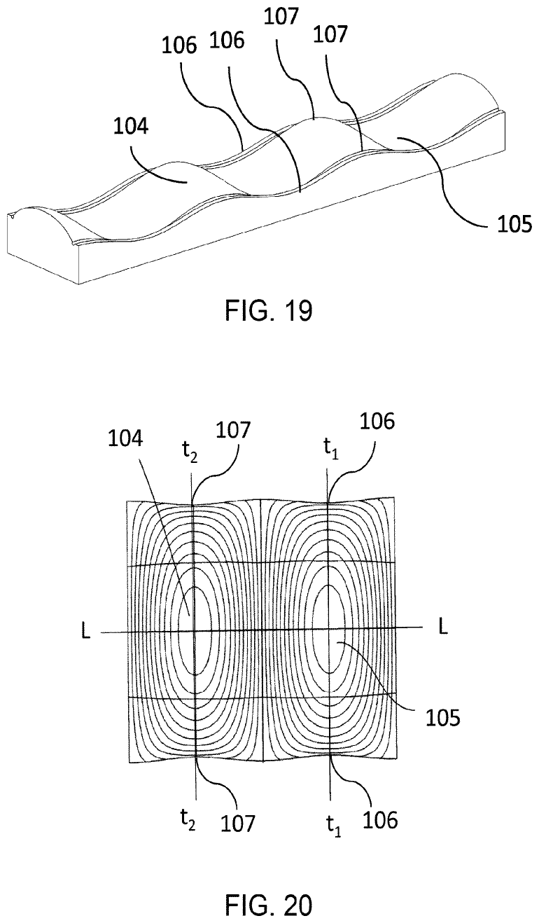

FIG. 19 shows the bottom piece 103 of the substantially flat tyre base layer mold 100 having a plurality of depressions and elevations.

FIG. 20 shows a contour map of the depressions and elevations along the substantially flat tyre base layer mold 100. The elevations and depressions in the longitudinal direction of the cavity of the substantially flat tyre base layer mold are shown along line L-L; 104 indicates a peak and 105 indicates a trough. A depression in the lateral direction is shown along Line t₁-t₁; a high point 106 decreases to a trough 105 and then increases to another high point 106. An elevation in the lateral direction is shown along line t₂-t₂; a low point 107 increases to a peak 104 and then decreases back to a low point 107.

Once the tyre base layer comprising stiffening elements is removed from the substantially flat tyre base layer mold 100, the depressions are reversed, that is inverted, in order that the tyre base layer comprising stiffening elements follows a single curvature in the longitudinal direction of the tyre base layer comprising stiffening elements. The curvatures provided by the depressions and elevations thus sum to form a segment of a circle once the depressions are inverted. Likewise, the depressions and elevations in the lateral direction now adopt complementary curvature to form the side walls of the segment of the circle and form the “Ω” shaped cross section.

Put another way, the curvature adopted by the tyre base layer comprising stiffening elements 20, 61 in the lateral direction assists in the formation of the side walls of the base layer within the tyre, and hence the “Ω” cross section. The curvature adopted by the tyre base layer comprising stiffening elements 20, 61 in the longitudinal direction of the base layer assists in the formation of the tyre annular loop.

FIG. 21 shows the tyre base layer comprising stiffening elements 20, 61 pre-shaped to comprise a substantially flat shape comprising depressions and elevations in the longitudinal and transverse direction.

In some examples, the substantially flat shaped tyre base layer comprising stiffening elements is stored having said form and may later be used in further processes to form a tyre. In some examples, the substantially flat shaped tyre base layer comprising stiffening elements is directly used in further processes to form a tyre and the inversion of the depressions and elevations takes place following subsequent processing steps.

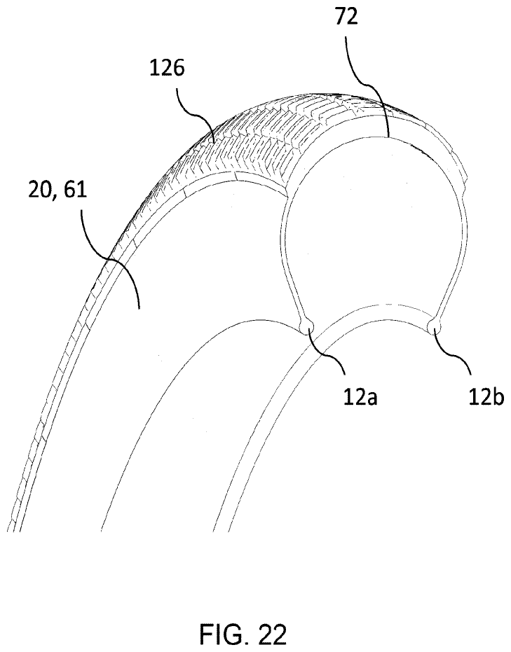

FIG. 22 shows a cross section of a tyre comprising a base layer formed from the base layer comprising stiffening elements 20, 61 described above. The tyre comprises a tread 126 applied to the middle wall 72 of the base layer. In some examples the tread may extend along the side walls 74 and 78 of the tyre base layer. An injection molding apparatus is used to add tyre tread to the tyre base layer comprising stiffening elements 20, 61. The injection molding apparatus comprises a tread mold into which the tyre base layer comprising stiffening elements 20, 61 is placed. The tyre base layer comprising stiffening elements 20, 61 is positioned within the tread mold for overmolding to take place. An elastomer is injection molded on to the tyre base layer comprising stiffening elements 20, 61 in order to overmold the tread onto the tyre base layer comprising stiffening elements 20, 61. In examples where the tyre base layer is formed from a sheet of fabric or mesh fabric the injection molded material will penetrate through the tyre base layer and thus extend from one face of the tyre base layer to the opposite face of the tyre base layer.

Whether provided as belt of continuous tyre base layer (on a spool or otherwise), or provided as a cut-to-size section of tyre base layer comprising stiffening elements, and/or whether provided flat, or provided pre-shaped as discussed above, the tyre base layer comprising stiffening elements can be further processed to add a tyre tread using overmolding, an example of which is provide below.

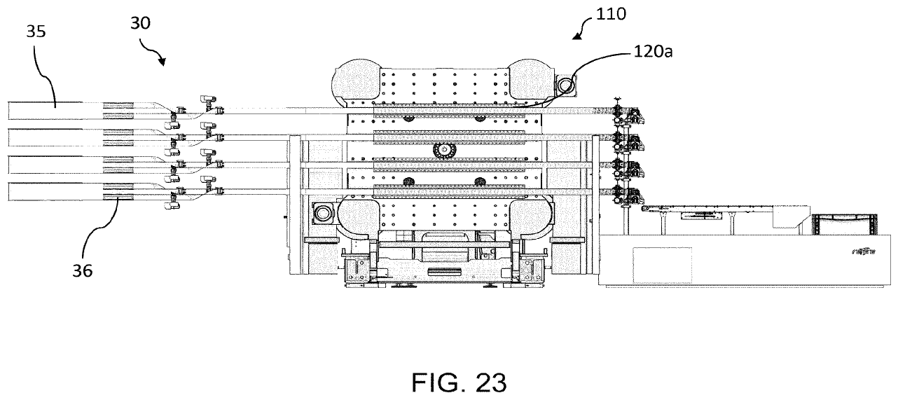

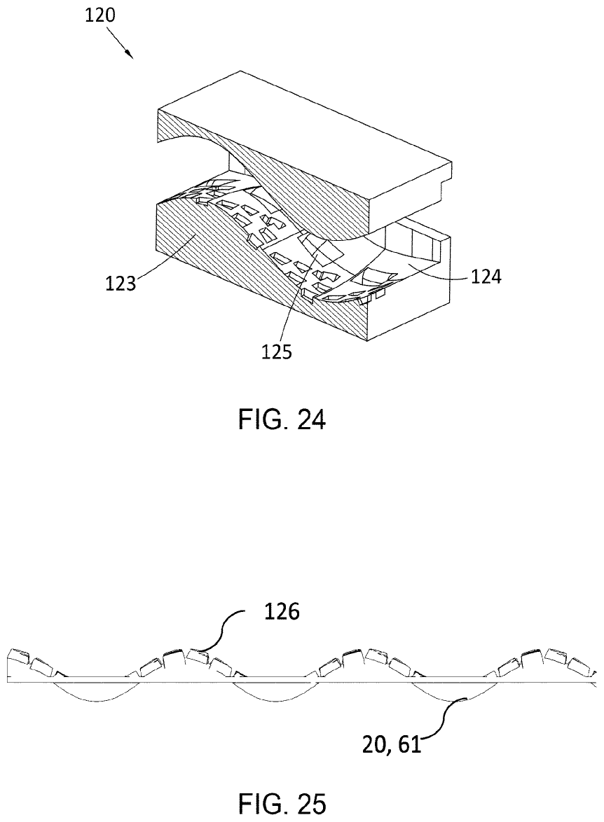

In FIG. 23, an injection molding apparatus 110 is shown which directly receives tyre base layer comprising stiffening elements 20, 61 in the form of a continuous belt of tyre base layer directly from the folding apparatus 30. The cavity of the tread mold 120 may have the substantially flat shape described above in relation to the tyre base layer mold and with reference to FIGS. 18 to 20. A substantially flat tread mold is shown below with reference to FIG. 24. A lower half 120a of the substantially flat tread mold 120 is provided on a stationary part of the injection molding apparatus 110 and an upper half 120b of the substantially flat tread mold 120 is provided on a part of the injection molding apparatus moveable relative to the stationary part. As the halves of the tread mold 120 are separated the continuous belt of tyre base layer is fed from the folding apparatus 30 and aligned with the lower half of the tread mold 120a. The upper half 120b of the tread mold is moved in order to close the mold 120 and a thermoplastic injected into the cavity of the mold. Once the injected thermoplastic has set and adopted the shape of the cavity of the tread mold, the upper half of the tread mold 120b is moved away from the lower half 120a and the continuous belt of tyre base layer and overmolded tread is drawn from the tread mold. Simultaneously with the movement of the continuous belt of tyre base layer and overmolded tread, further tyre base layer comprising stiffening elements comprised then continuous belt is drawn into the injection molding apparatus 110 from the folding apparatus 30.

The continuous belt of tyre base layer can instead be fed into the injection molding apparatus 110 from a spool.

FIG. 24 shows a section of the substantially flat tread mold 120 which comprises a tread pattern 125 on the cavity wall 124 of the lower piece 123.

FIG. 25 shows tyre base layer with stiffening elements 20, 61 plus an overmolded tyre tread 126 having the substantially flat shape. The substantially flat shape of the combined tread 126 and tyre base layer comprising stiffening elements 20, 61 is a result of the overmolding step, that is, a flat belt of tyre base layer can be inserted into the tread mold 120 and the application of the elastomer to form the tread 126 combined with the application of heat and pressure during the overmolding process causes the tyre base layer comprising stiffening elements 20, 61 to adopt a shape comprising the depressions and elevations of the substantially flat tread mold 120. In other examples, the tyre base layer comprising stiffening elements is pre-shaped before entering the substantially flat tread mold 120 and the shape of the tyre base layer and tread following overmolding may be a contribution of the tread molding process and the pre-shaping.

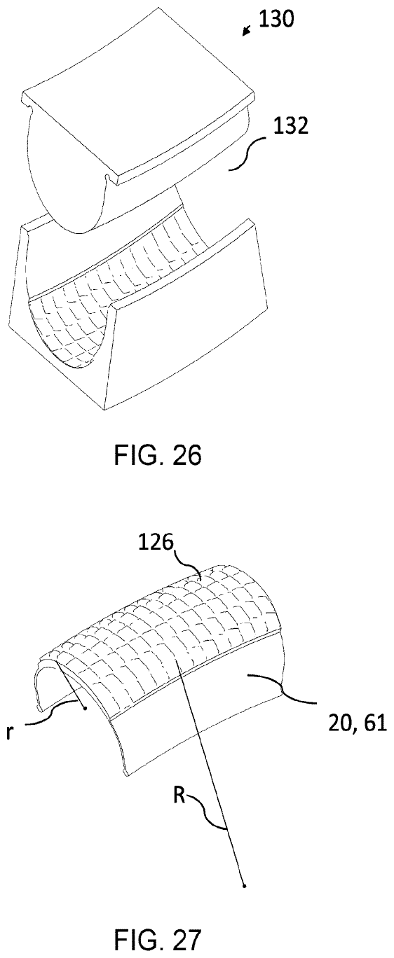

FIG. 26 shows a segment tread mold 130 comprising a cavity 132 shaped as a segment of a double curved tyre shape. FIG. 27 shows the tyre base layer comprising stiffening elements 20, 61 plus an overmolded tread 126 formed using the segment tread mold 130 which comprises the double curved tyre shape of radius r and R described above. The double curved tyre shape of the combined overmolded tread 126 and tyre base layer 20, 61 may be a result of the application of the elastomer to form the tread 126 combined with the application of heat and pressure during the overmolding process. Pre-shaped tyre base layer comprising stiffening elements 20, 61 can be inserted into the segment mold 130, the shaping of which can contribute to the final shape of the combined tread 126 and tyre base layer comprising stiffening elements 20, 61.

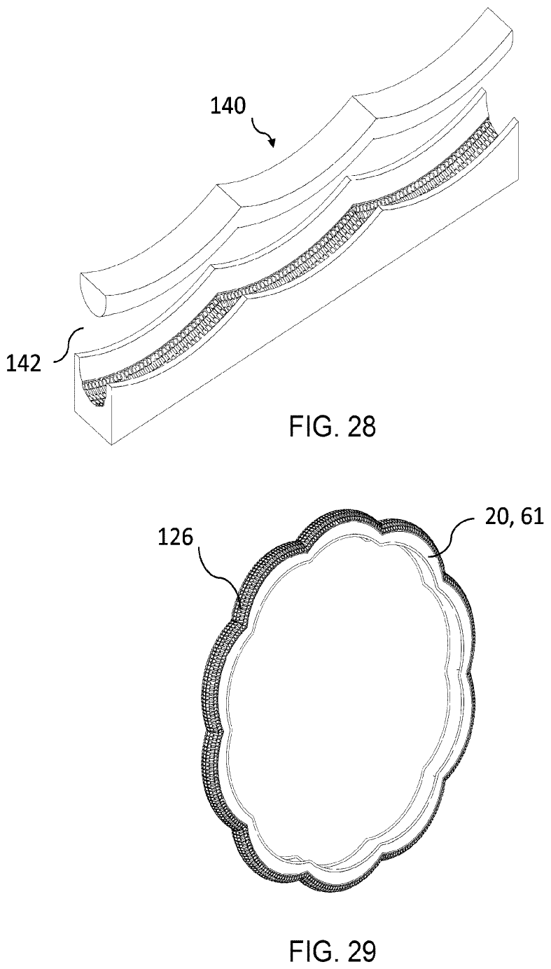

FIG. 28 shows a tread mold 140 comprising a cavity 142 shaped as a plurality of segments of a double curved tyre shape. FIG. 29 shows a resulting tyre base layer comprising stiffening elements 20, 61 plus an overmolded tread 126. The joins between adjacent segments of the base layer and overmolded tread have been manipulated (e.g. bent or stretched) compared to the shape of the cavity of the tread mold 140 in order to form a continuous curvature. The shape shown in FIG. 29 can be further manipulated into a circular tyre shape if required.

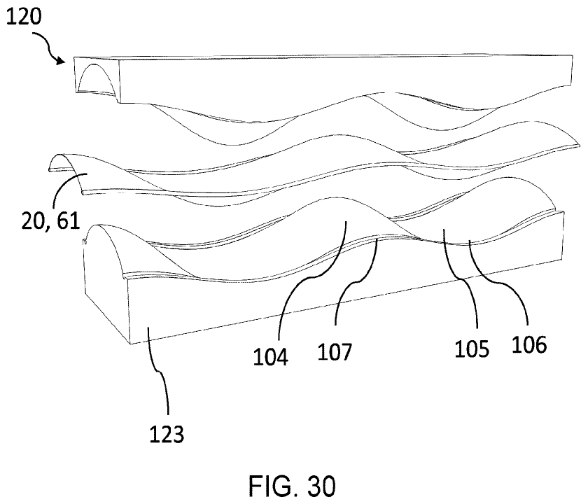

The tyre base layer comprising stiffening elements 20, 61 can be pre-shaped as described above, and the tread subsequently overmolded on to the pre-shaped tyre base layer. In some examples, dimensions of the tyre base layer are larger than the dimensions of the tread mold. As shown in FIG. 30, when the tyre base layer comprising stiffening elements 20, 61 is pre-shaped to comprise a substantially flat shape, the amplitude and wavelength of the depressions and elevations is larger than the equivalent amplitude and wavelength of the substantially flat tread mold 120. That is, the change in height between the low point 107 and the peak 104, the high point 106 and the trough 105 and the distance between the peak 104 and trough 105 of the tread mold 120 are smaller than those distances of the pre-shaped tyre base layer. The tread pattern 125 of the tread mold 120 of FIG. 30 has been omitted for clarity.

The relative differences in the amplitude and wavelength of the depressions and elevations between the pre-shaped tyre base layer and the tread mold differ depending on the thermal expansion properties of the tyre base layer and the elastomer of the tread. In some cases, the amplitude and wavelength of the depressions and elevations is larger of the substantially flat tread mold 120 than the equivalent amplitude and wavelength of the pre-shaped tyre base layer. Alternatively, some dimensions may be larger in the substantially flat tread mold while some dimensions are smaller compared to the pre-shaped tyre base layer.

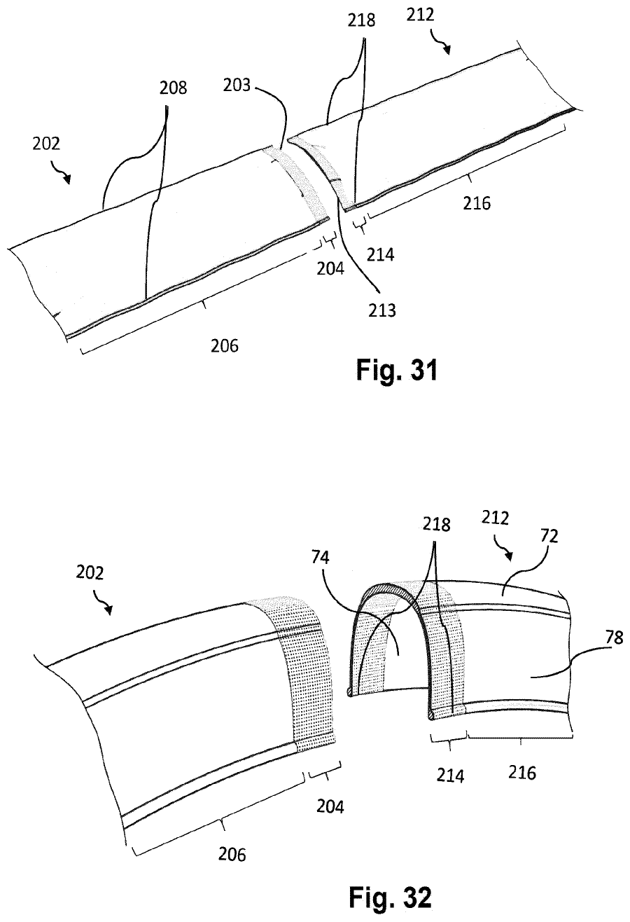

FIG. 31 shows a first length of tyre base layer 202 and a second length of tyre base layer 212. The first length of tyre base layer 202 comprises a first end portion 204, a first main portion 206, and a first pair of stiffening elements 208. The second length of tyre base layer 212 comprises a second end portion 214, a second main portion 216, and a second pair of stiffening elements 218. The first and second tyre base layer end portions 202, 212 are aligned as shown and joined in order that the stiffening elements of the first and second pairs of stiffening elements 208, 218 align.

The first and second lengths of tyre base layer may be flat as shown in FIG. 31. The first and second lengths of tyre base layer may instead be pre-shaped in order to comprise a curve. As shown in FIG. 32, the first and second lengths of tyre base layer may be pre-shaped in order to have a double curved shape, i.e. comprises a curvature having a radius of curvature r in a lateral cross section and a curvature having a radius of curvature R in a cross section perpendicular to the longitudinal cross section of the cylindrical tyre. The double curved tyre shape can also be described as an annular segment having an omega “Ω” cross section. The base layers will then have first and second side walls 74, 78 and middle wall 72 as described above.

The first and second lengths of tyre base layer 202, 212 can be produced in a known way.

The first and second lengths of tyre base layer 202, 212 can be made using any steps of the method described above for manufacturing a continuous belt of tyre base layer. Prior to the joining operation the continuous belt of tyre base layer can be cut into the first and second lengths of tyre base layer separate to one another and each having a predetermined length. Alternatively, prior to the joining operation the continuous belt of tyre base layer can be cut into a single piece of predetermined length and the first.

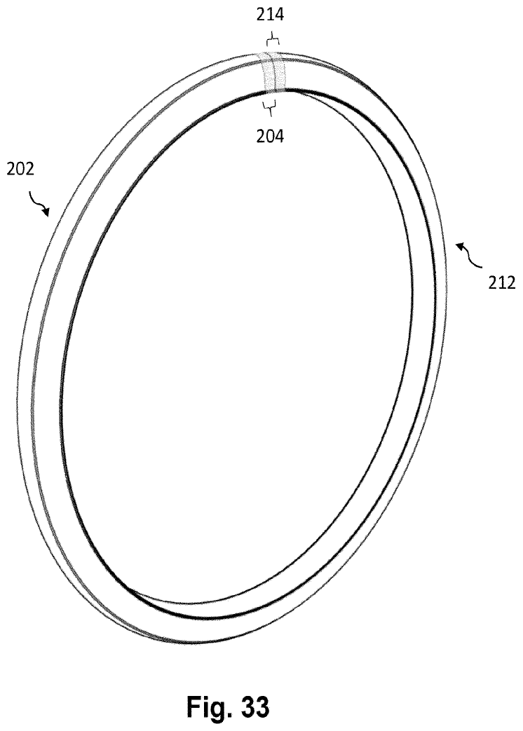

The first and second lengths of tyre base layer 202, 212 can be continuous as shown in FIG. 33. That is, the first end portion 204 and the second end portion 214 are disposed at longitudinal ends of a single piece of tyre base layer. Thus, a complete loop of tyre base layer is made requiring a single join.

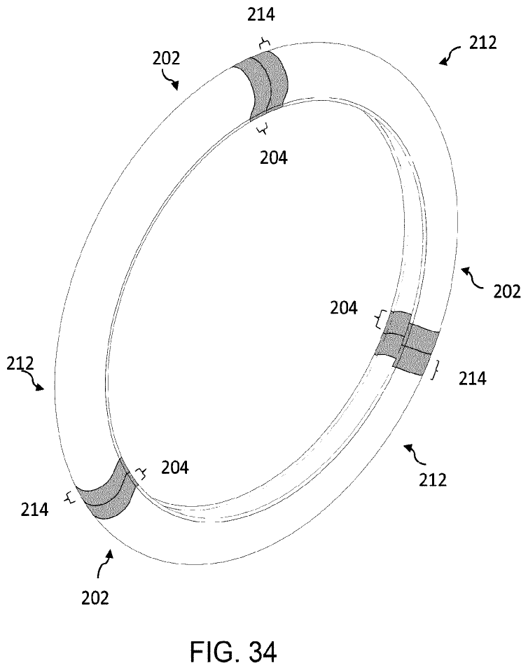

In other examples, multiple joins are required to form a complete loop of base layer suitable for use in a tyre. As shown in FIG. 34 where the first length of tyre base layer 202 of one join also provides the second length of tyre base layer 212 for another join.

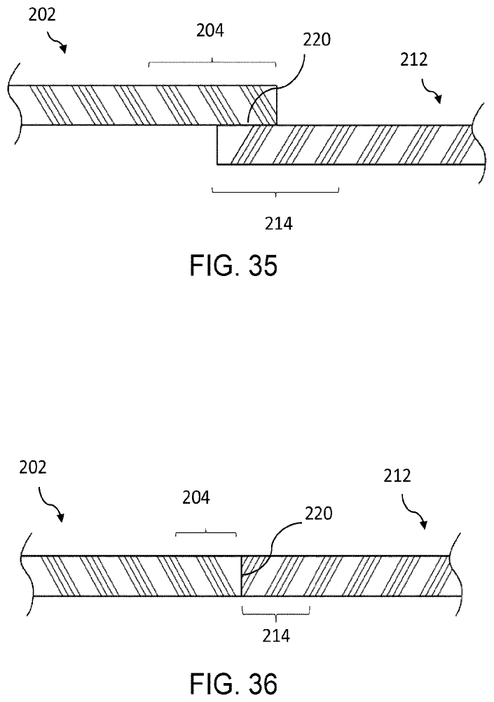

A region of contact 220 is made between the first and second end portions 204, 214. This is shown in FIGS. 35 and 36. In FIG. 35 the region of contact 220 is formed by overlapping the first end portion 204 with the second end portion 214 to form a double thickness of tyre base layer in the region of contact 220. In FIG. 36, the region of contact 220 is formed by abutting a longitudinal face of the first length of base layer 203 (shown in FIG. 31) with a longitudinal face of the second length of base layer 213 (shown in FIG. 31).

A welding operation can then be performed in the region of contact to secure the first and second lengths of tyre base layer 202, 212 to one another. The first and second lengths of tyre base layer 202, 212 can be secured additionally or alternatively by providing a glue or adhesive material between the first and second lengths of tyre base layer 202, 212 in the region of contact.

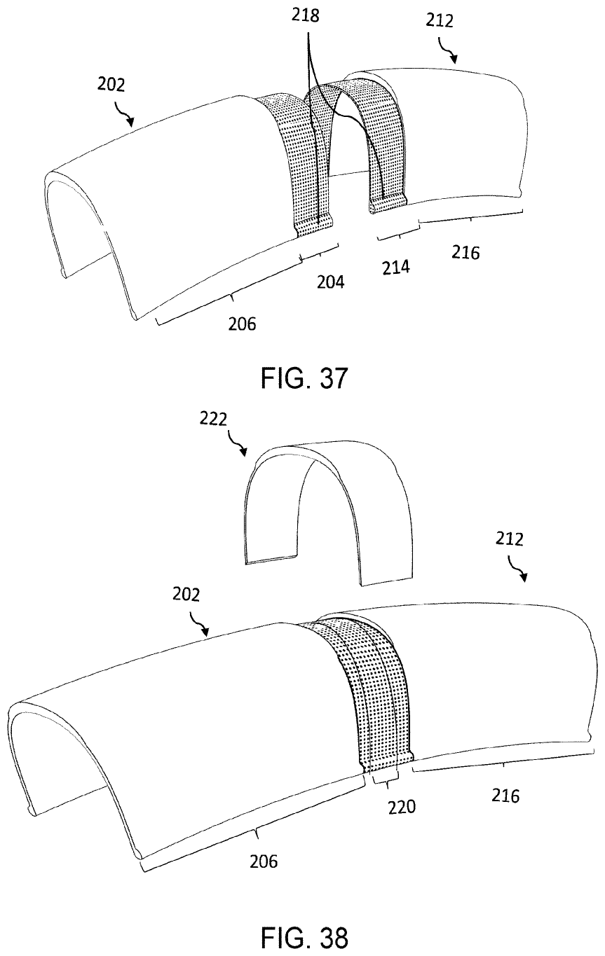

In FIG. 37, an example is shown wherein the first and second end portions 204, 214 comprise only a mesh fabric, whereas the first and second main portions 206, 216 comprise a mesh fabric and an elastomer. A region of contact 220 (shown in FIG. 38) will be made between at least a portion of the first end portion 206 and at least a portion of the second end portion 216 by at least partly overlapping the two end portions 204, 214. The joining of the two end portions 204, 214 can then be performed by overmolding an elastomer over the first end portion 204, the region of contact 220 and the second end portion 214. The piece 222 represents the overmolded piece that will added to the joined baselayer once the overmolding process is carried out. The piece 222 will thus extend from and join the first main portion 206 to the second main portion 216. By ensuring the end of the region of contact 220 and the join of the overmolded elastomer to the first and second main portions 206, 216 are misaligned, a stronger join can be made by avoiding weak points from each join being aligned. However, it is adequate results can be achieved by completely overlapping the first and second end portions 214, 204 to form the contact region 220. Since the mesh fabric has an open structure, the elastomer can infiltrate the mesh fabric to create a strong join by improving both the mechanical bonding between the first and second base layers as well as the chemical bonding between the elastomer and the fibres. Similar advantages can be realised using this process with other base layer materials comprising fibres.

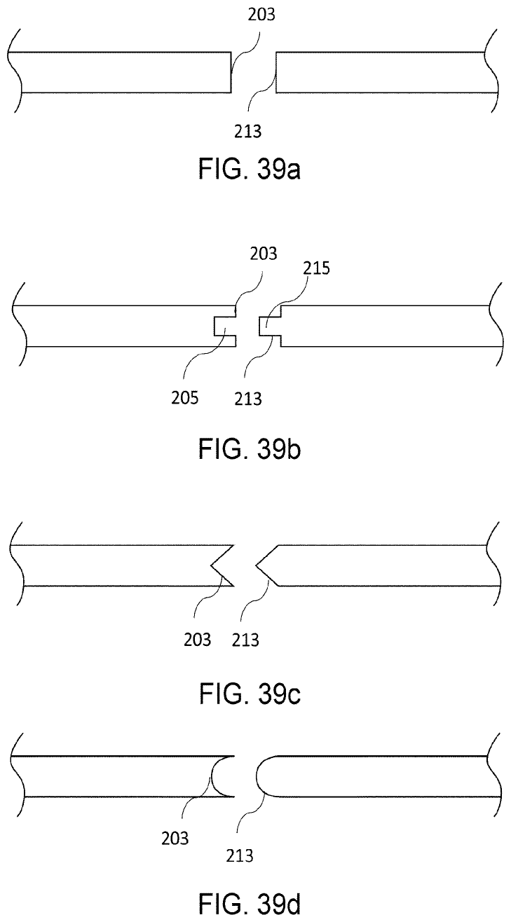

In particular, when the region of contact 220 is created by abutting longitudinal end faces of the first and second lengths of base layer 203, 213, the end faces 203, 213 can have complementary shapes as shown in FIGS. 39a to 39d so that the faces interlock when joined. In FIG. 39a, the end faces 203, 213 each have a straight shape oriented perpendicular to the longitudinal length of the respective first and second length of tyre base layer. In FIG. 39b the end faces have a plurality of lengths perpendicular to the length of the tyre base layer, the plurality of lengths form a stepped shape which provides more surface area of contact between the end faces. The longitudinal end face of the first length of tyre base layer 203 has such a stepped shape to also have an indent 205 and the longitudinal end face of the second length of tyre base layer 213 has such a stepped shape to also have a protrusion 215. The protrusion 215 fits within the indent 205. In FIG. 39c the longitudinal end face of the second length of tyre base layer 213 has an extending chevron shape, and the longitudinal end face of the first length of tyre base layer 203 has a cut-away chevron shape. The chevrons are formed of a plurality of lengths non-perpendicular to the longitudinal length of the tyre base layer. In FIG. 39d the longitudinal end face of the second length of tyre base layer 213 has a convex curved shape, and the longitudinal end face of the first length of tyre base layer 203 has a concave curved shape.

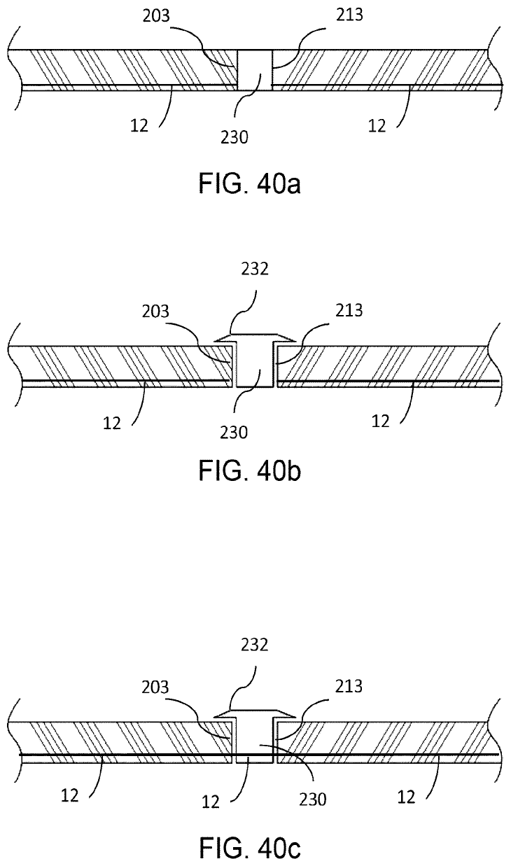

An insert 230 can be placed between the first and second lengths of tyre base layer 202, 212. The insert 230 shown in FIG. 40a is positioned between the end faces 203, 213. The stiffening elements 12 of the first and second lengths of tyre base layer 203, 213 align once joined. The insert is secured to each of the end faces 203, 213 in order to secure the first and second lengths of tyre base layer 202, 212 to one another. FIG. 40b shows an insert 230 comprising an insert head portion 232 that protrudes above the first and second lengths of tyre base layer 202, 212 and that extends laterally and longitudinally over the first and second lengths of tyre base layer 202, 212, extending over the end portions 204, 214 and/or main portions 206, 216.

In FIG. 40c an example is shown in which the pair of stiffening elements 12 extend through the insert 230 so that connection can be made between the first and second pairs of the stiffening elements in the first and second length of tyre base layer respectively.

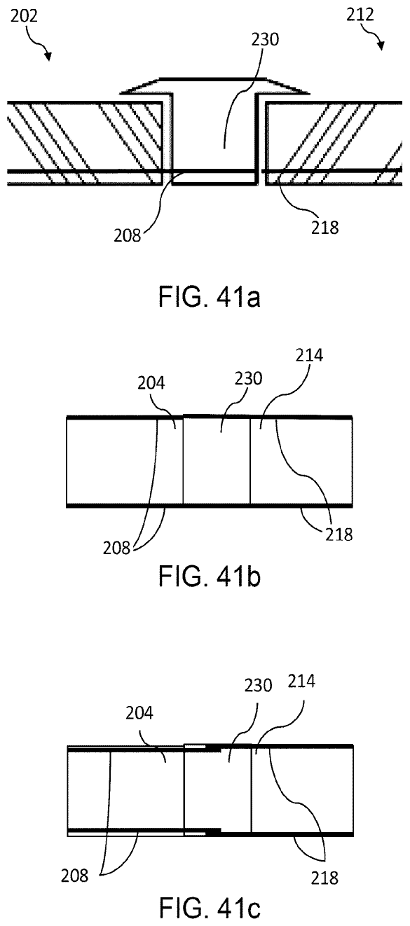

FIG. 41a shows an expanded view of the join, i.e. before contact is made and the join completed. FIG. 41a shows stiffening elements 208 of the first length of tyre base layer 202 extending from the first end portion 204. The first pair of stiffening elements 208 overlap the second pair of stiffening elements 218 in the longitudinal direction, hence the tips of the pairs of stiffening elements will abut one another once the join is made. The tips can then be joined via welding, soldering, sewing or an adhesive. For example, the sewing of aramid stiffening elements may be executed with an aramid thread. FIG. 41b shows this situation in plan view. FIG. 41c shows a similar example with both the first and second pairs of stiffening elements 208, 218 extending from the first and second end portions 204, 214 respectively, however the stiffening elements overlap in a lateral direction.

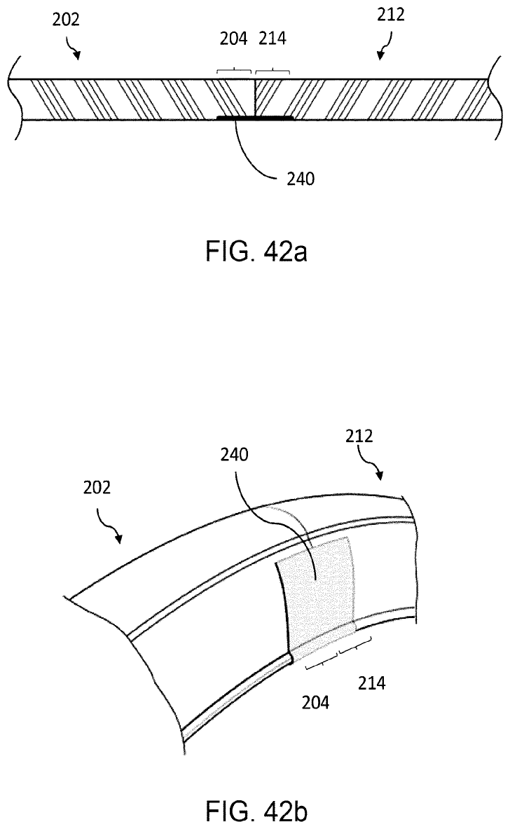

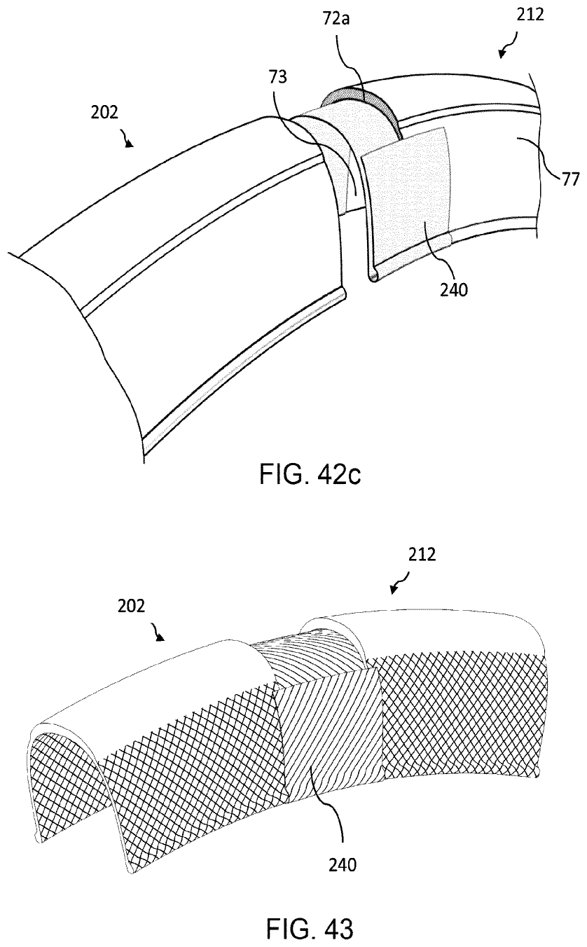

FIG. 42a shows a join between the first and second lengths of tyre base layer 202, 212 that comprises a liner material 240 bonded to the first and second end portions 204, 214.

FIG. 42b shows an example wherein the first and second lengths of tyre base layer 202, 212 are shaped with a double curved shape. FIG. 42c shows an expanded view of FIG. 42b (i.e. without the contact and join having been made) which shows the position and extent of the liner material 240 about the join. The liner material 240 extends from a radially outer surface (not shown) of the first side wall 74 relative the radius of curvature r, to the radially inner surface 73 of the first side wall 74 relative the radius of curvature r, along the radially inner surface 72a of the middle wall 72 relative the radius of curvature r, along the radially inner surface (not shown) of the second side wall 78 and to the outer surface 77 of the second side wall 78.

The liner 240 can extend around the entire join and can be considered to be a sleeve. The sleeve 240 can be tight enough, and/or comprise an adhesive, sufficient to secure the first and second lengths of tyre base layer 202, 212 to one another. In some examples the liner 240 comprises fibres providing additional strength.

FIG. 43 shows an example wherein the liner 240, first length of tyre base layer 202 and second length of tyre base layer 212 comprise fibres. A fibre direction of each component is indicated in the figure by the direction of the cross hatching. The fibre direction of the liner 240 substantially aligns with a fibre direction of the first and second length of tyre base layer 202, 212. In some examples the liner 240 additionally or alternatively comprises fibres that extend in the longitudinal direction of the first and second lengths of tyre base layers 202, 212. It will be understood that the liner and/or first and second lengths of tyre base layer can additionally comprise fibres extending in alternative directions to those indicated in FIG. 43.

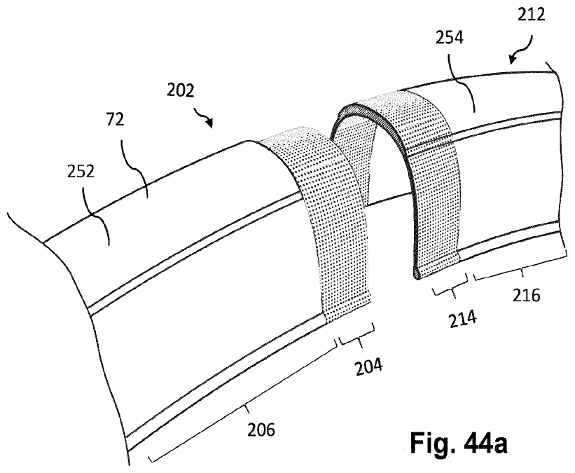

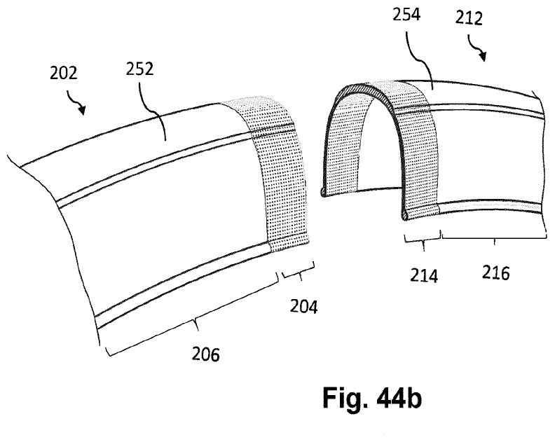

In FIG. 44a, the first length of tyre base layer 202 comprises a first tread portion 252 and the second length of tyre base layer 212 comprises a second tread portion 254. The first tread portion 252 is disposed above the first main portion 206 of the first length of tyre base layer 202 on the middle wall 72, but does not extend over the first end portion 204. The second tread portion 254 is disposed above both the second main portion 216 and the second end portion 214. Once the join is made according to any of the discussion above, the first end portion is disposed beneath (radially inwardly of) the second end portion such that the first tread portion 252 abuts the second tread portion 254.

In FIG. 44b the first tread portion 252 extends over both the first main portion 206 and the first end portion 204, and the second tread portion 254 extends over the second main portion 216 and the second end portion 214. The region of contact 220 is provided by the longitudinal end faces of the first and second lengths of tyre base layer and tread portions so that the first and second lengths of tyre base layer are secured to one another and the first and second tread portions are secured to one another.

In examples where an insert 230 is used the insert can comprise an insert tread portion 234 which may be provided on the insert head portion 232 or in place of the insert head portion 232.

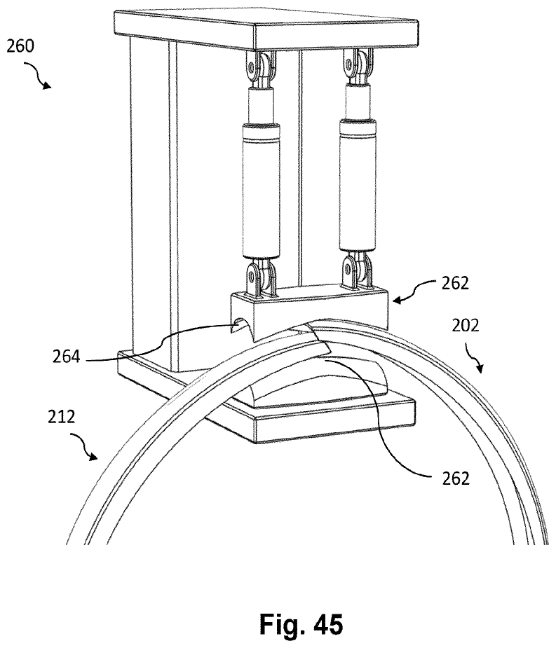

FIG. 45 shows a joining apparatus 260 used to join the first and second lengths of tyre base layer 202, 212. The joining apparatus comprises a clamp 262 for maintaining the first and second lengths of tyre base layer in position so that the end portions 204, 214 can be joined appropriately. The joining apparatus shown in FIG. 45 is configured to apply heat and pressure between a top clamp surface 264 and a bottom clamp surface 266 in order to form the join.

1. A method of providing a join between a first tyre base layer end portion and a second tyre base layer end portion, the method comprising:
providing a first length of tyre base layer comprising a first end portion, a first main portion, and a first pair of stiffening elements;
providing a second length of tyre base layer comprising a second end portion, second main portion and a second pair of stiffening elements;
joining together the first end portion and the second end portion such that each of the stiffening elements of the first pair of stiffening elements align with a corresponding stiffening element of the second pair of stiffening elements.

2. A method as claimed in claim 1, wherein the first pair of stiffening elements comprises a first pair of bead wires and the second pair of stiffening elements comprise a second pair of bead wires.

3. A method as claimed in claim 1 or 2, wherein the first length of tyre base layer is continuous with the second length of tyre base layer, such that the first end portion and second end portion are opposite longitudinal ends of a single tyre base layer.

4. A method as claimed in claim 1, 2 or 3, comprising joining the first end portion to the second end portion via a sleeve, a seam, a weld, a solder and/or a glue.

5. A method as claimed in claim any of claims 1 to 4, wherein joining together the first end portion and the second end portion comprises:
creating a region of contact between the first and second end portions of the tyre base layer; and
performing a welding operation to bond the first and second end portions within the region of contact.

6. A method as claimed in any preceding claim, wherein the joining together of the first and second lengths of tyre base layer comprises creating a region of contact between the first and second end portions of the tyre base layer; and the method comprises:
providing a glue within the region of contact and applying pressure to the region of contact.

7. A method as claimed in any of claim 5 or 6, wherein creating a region of contact between the first and second end portions of the tyre base layer comprises placing the first end portion above the second end portion.

8. A method as claimed in any of claim 5, or 6, wherein the first end portion is a first longitudinal face of the first length of tyre base layer, and the second end portion is a second longitudinal face of the second length tyre base layer; and wherein creating a region of contact between the first and second end portions comprises abutting the first end portion against the second end portion.

9. A method as claimed in 8, wherein first and second longitudinal ends of the length of tyre base layer have complementary shapes such that when the first and second end portions of the length of tyre base layer are abutted, a continuous tyre base layer with parallel sides is produced.

10. A method as claimed in claim 9, wherein the first and second longitudinal ends are either:
shaped as a single length perpendicular to the length of tyre base layer;
shaped as a plurality of lengths each perpendicular to the length of tyre base layer;
shaped as non-perpendicular to the length of tyre base layer; or
shaped as a curve, or plurality of curves.

11. A method as claimed in any of claims 5 to 10, wherein the stiffening elements extend in a longitudinal direction from the first and/or second end portions of the respective first and second lengths of tyre base layer such that when the contact region is formed the stiffening elements abut and/or overlap.

12. A method as claimed in claim 1, 2 or 3, wherein the joining together of the first and second end portions comprises disposing an insert between the longitudinal faces of the first and second lengths of tyre base layers.

13. A method as claimed in claim 12, wherein the insert comprises a head portion that extends at least partly over the first end portion and second end portions.

14. A method as claimed in claim 12 or 13, wherein the stiffening elements extend in a longitudinal direction from the first and/or second end portions of the respective first and second lengths of tyre base layers such that when the insert is disposed between the longitudinal faces of the first and second lengths of tyre base layers, the stiffening elements abut and/or overlap.

15. A method as claimed in claim 14, wherein the stiffening elements of the first pair of stiffening elements may be joined to a corresponding stiffening element of the second pair of stiffening elements via a sleeve, a seam, a weld, a solder or a glue.

16. A method as claimed in any preceding claim, wherein the method comprises:
bonding a liner material to the first and second lengths of tyre base layers so as to overlap the join between the first and second end portions.

17. A method as claimed in claim 16, wherein the liner material and the first and second lengths of tyre base layer comprise fibres, and wherein the liner material is bonded to the first and second lengths of tyre base layer such that the fibres of the liner material align with the fibres of the first and second lengths of tyre base layer.

18. A method as claimed in claim 16 or 17, wherein the liner material comprises fibres such that once bonded to the first and second lengths of tyre base layers, the liner material comprises fibres aligned to the longitudinal length of the tyre base layer.

19. A method as claimed in claim 16, 17 or 18, wherein the liner material is disposed on a lower surface of the first and second main portions.

20. A method as claimed in claim 19, wherein the liner material extends continuously from the lower surface of the first and second main portions, over longitudinal edges of the lengths of base layers and to an upper surface of the first and second lengths of base layer.

21. A method as claimed in any of claims 16 to 20, wherein the liner material is placed in position over the join prior to joining the first and second end portions.

22. A method as claimed in any of claims comprising:
performing the method of any preceding claim a sufficient number of times to create a circular loop of tyre base layer.

23. A method as claimed in any preceding claim, wherein the first and second lengths of tyre base layer comprises a double curved tyre shape, wherein the double curved tyre shape has a radius r in a lateral cross section and a radius of curvature R in a cross section perpendicular to the lateral cross section.

24. A method as claimed in claim 23, the method comprising:
applying heat to the tyre base layer and stretching the tyre base layer over the surface of a wheel causing the tyre base layer to adopt a double curved tyre shape.

25. A method as claimed in claim 23, wherein providing each of the first and second lengths of tyre base layer with a double curved shape comprises providing a substantially flat shaped length of tyre base layer, wherein the substantially flat shape comprises at least one depression and at least one elevation, wherein each depression and elevation extends and slopes in both a lateral and a longitudinal direction of the tyre base layer.

26. A method as claimed in claim 25, wherein the length of tyre base layer comprising a double curved tyre shape is manufactured by:
providing a length of tyre base layer;
inserting the length of tyre base layer within a cavity of a base layer mold; and
applying heat and pressure; wherein:
the base layer mold is a substantially flat mold comprising a housing comprising at least one longitudinal inner cavity extending between at least two opposing main walls and two opposing edge walls, wherein:
each of the main walls has at least one elevation and at least one depression;
each elevation and each depression extends and slopes in both a lateral and a longitudinal direction of the cavity;
the elevations and depressions are arranged alternately along the length of the mold; and
an elevation of one main wall is opposite a depression of the other main wall.

27. A method as claimed in claim 23, wherein the length of tyre base layer comprising a double curved tyre shape is manufactured by:
providing a length of tyre base layer;
inserting the length of tyre base layer within a cavity of a base layer mold; and
applying heat and pressure; wherein:
the base the shape of each of the first and second lengths of tyre base layer comprises a segment of cylindrical tyre.

29. A method as claimed in any preceding claim, wherein the first and/or second length of tyre base layer comprises a tread.

30. A method as claimed in claim 29, wherein the tread is an overmolded tread and is provided by;
inserting a length of the tyre base layer into a tread mold;
injecting an elastomeric material into the tread mold;
allowing the elastomeric material to set in order that the elastomeric material and tyre base layer adopt the shape of the tread mold; and
removing the bonded tyre base layer and elastomeric material from the tread mold.

31. A method as claimed in claim 30, wherein the tread mold is a substantially flat tread mold comprising a housing comprising at least one longitudinal inner cavity extending between at least two opposing main walls and two opposing edge walls, wherein:
each of the main walls has at least one elevation and at least one depression;
each elevation and each depression extends and slopes in both a lateral and a longitudinal direction of the cavity;
the elevations and depressions are arranged alternately along the length of the tread mold; and
an elevation of one main wall is opposite a depression of the other main wall.

32. A method as claimed in claim 31, wherein the first and/or second length of tyre base layer is provided according to claim 25, wherein the dimensions of the depressions and elevations of the tyre base layer are greater than the dimensions of the depressions and elevations of the tread mould.

33. A method as claimed in claim 30, wherein the shape of a cavity of the tread mould comprises at least one segment of a cylindrical tyre.

34. A method as claimed in claim 33, wherein the first and second lengths of tyre base layer are provided according to any of claims 22 to 27 and the radius of curvature adopted by the first and second lengths of tyre base layer is larger than the radius of curvature of the cavity of the tread mould.

36. A method as claimed in any preceding claim when dependent on claims 7 to 15, wherein the first end portion, the first main portion and the second main portion comprise a tread and the second end portion does not comprise a tread, and the joining of the first end portion and second end portion comprises joining the tread of the first end portion to the tread of the second main portion, and/or joining the tread of the first end portion to the tyre base layer of the second end portion.

37. A method as claimed in claim 36, wherein the tread of the first end portion extends beyond the tyre base layer of the first end portion in the longitudinal direction of the tyre base layer.

38. A method as claimed in any preceding claim, wherein the first and second lengths of tyre base layer are each provided by:
providing a sheet of material having a first lateral edge portion, and a second lateral edge portion, wherein the first lateral edge portion is separated from the second lateral edge portion by a central portion,
laying a first stiffening element on the sheet where the first lateral edge portion and central portion meet, and laying a second bead wire on the sheet where the central portion and second lateral edge portion meet,
folding the first lateral edge portion over the first stiffening element,
folding the second lateral edge portion over the second stiffening element, and
securing the first lateral edge portion and the second lateral edge portion to the central portion.

39. A method as claimed in claim 38 wherein the first and or second lengths of base layer are provided in the form of a continuous belt of tyre base layer.

40. A tyre manufactured according to the method of any preceding claim.

41. An apparatus for joining a first length of tyre base layer and a second length of tyre base layer, the apparatus comprising a clamp for positioning a first end portion of a first length of tyre base layer and a second end portion of a second length of tyre base layer, and for performing a welding operation to bond the first and second end portions.

41. An apparatus as claimed in claim 40, comprising a means for cutting a continuous belt of tyre base layer into a desired length for the first and/or second length of tyre base layer.
